(19) United States
(12) Patent Application Publication
(10) Pub. No.: US 2026/0122024 A1
(43) Pub. Date: Apr. 30, 2026

(54) METHODS BY WHICH ELECTRONIC DEVICE AND SERVER DEVICE PROCESS MESSAGE

(71) Applicant: Samsung Electronics Co., Ltd., Suwon-si (KR)

(72) Inventors: Kyujin HAN, Suwon-si (KR); Juho KIM, Suwon-si (KR); Minsun KIM, Suwon-si (KR)

(21) Appl. No.: 19/432,466

(22) Filed: Dec. 24, 2025

Related U.S. Application Data
(63) Continuation of application No. PCT/KR2024/009460, filed on Jul. 4, 2024.

(30) Foreign Application Priority Data
Jul. 11, 2023 (KR) 10-2023-0090085
Aug. 24, 2023 (KR) 10-2023-0111041

(51) Int. Cl. H04L 51/216; G06F 16/13; H04L 12/18

(52) U.S. Cl. CPC H04L 51/216; G06F 16/13; H04L 12/18

(57) ABSTRACT

A server device may include: a communication interface; a memory; and a processor operatively connected to the communication interface and the memory. The processor may be configured to: based on a group chat of a group including a first electronic device being initiated, generate a conversation history folder including data related to the group chat and store the conversation history folder in the memory; in response to occurrence of an event related to the group chat, generate a conference information object including information about the event and store the conference information object in the conversation history folder; and transmit the generated conference information object to a first electronic device and a second electronic device corresponding to the first electronic device, through the communication interface.

### CROSS-REFERENCE TO RELATED APPLICATIONS

This application is a continuation of International Application No. PCT/KR2024/009460 designating the United States, filed on Jul. 4, 2024, in the Korean Intellectual Property Receiving Office and claiming priority to Korean Patent Application Nos. 10-2023-0090085, filed on Jul. 11, 2023, and 10-2023-0111041, filed on Aug. 24, 2023, in the Korean Intellectual Property Office, the disclosures of each of which are incorporated by reference herein in their entireties.

### BACKGROUND

### Field

The disclosure relates to an electronic device and a server device and, for example, to an electronic device capable of transmitting and receiving a message written by a user and a server device capable of transmitting, receiving, and storing messages transmitted and received by various electronic devices.

### Description of Related Art

With the development of mobile communication technology, a portable electronic device (hereinafter, an electronic device) may provide a user experience via various data communication functions. An electronic device may provide a message service, such as a short message service (SMS) or a multimedia message service (MMS), which allows transmission of a message written by a user to a counterpart, and recently, a message service based on a rich communication service (RCS) which may substitute for the legacy service, such as SMS or MMS, has been provided.

The RCS is a standard for a message service via cellular wireless communication, and includes a communication protocol based on an Internet Protocol Multimedia Subsystem (IMS). The RCS has various advantages such as an increased message length, a read confirmation function, and ease of integration with other applications, as compared to legacy services such as SMS or MMS, and is thus widely used. In addition, the RCS may provide a group chat to which multiple users may participate in real time, and may also provide transfer of large files.

When a group chat based on the RCS is used in an electronic device, the RCS needs to be supported in a platform (or operating system) of the electronic device. However, group chat information synchronization may be required even in a device that does not support the RCS. For example, a user of the electronic device may want to check group chat information from another device (e.g., a laptop PC) that does not support the RCS. To this end, group chat synchronization may be provided by a message store server on a network. The message store server may be integrated with an RCS server so as to provide group chat information to a device that does not support the RCS.

A message store server may generate various objects including information on an event occurring in a group chat for group chat synchronization, store the generated objects, and transmit the generated objects to other servers and/or electronic devices. The RCS standard defines a structure of various types of objects and folders in which the objects are stored in a complex manner. In such the RCS standard, there are many types of folders and objects used for group chat synchronization, and therefore, the structure may be complicated and the implementation may be difficult. In addition, a transaction for generating and exchanging an object may frequently occur, and the type and amount of data required for generating an object may increase.

### SUMMARY

A server device according to an example embodiment may include: a communication interface comprising circuitry, a memory, and at least one processor, comprising processing circuitry, operatively connected to the communication interface and the memory.

According to an example embodiment, at least one processor, individually and/or collectively, may be configured to cause the server device to: based on a group chat of a group including a first electronic device being initiated, generate a conversation history folder including data related to the group chat and store the generated folder in a memory, generate, in response to occurrence of an event related to the group chat, a conference information object including information on the event and store the generated object in the conversation history folder, and transmit the generated conference information object to the first electronic device and the second electronic device corresponding to the first electronic device via the communication interface.

A method of processing a message by a server device according to various example embodiments may include: based on a group chat of a group including a first electronic device being initiated, generating and storing a conversation history folder including data related to a group chat, an operation of generating a conference information object including information on an event related to the group chat and storing the generated object in the conversation history folder, in response to occurrence of the event, and an operation of transmitting the generated conference information object to the first electronic device and a second electronic device corresponding to the first electronic device.

An electronic device according to various example embodiments may include: a display, a communication module comprising communication circuitry, a memory, and at least one processor, comprising processing circuitry, operatively connected to the display, the communication module, and the memory, wherein at least one processor, individually and/or collectively, may be configured to cause the electronic device to: perform a group chat function using a client stored in the memory, obtain, from an external message server via the communication module, a conference information object generated according to occurrence of an event related to the group chat, update information on the group chat, in response to the conference information object, and display the updated group chat information on the display.

According to various example embodiments of the disclosure, a message processing method may be provided, which may reduce the amount of data and the number of transactions on an electronic device and a server device by simplifying the structure of objects and folders when implementing a synchronization function of a group chat.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments.

FIG. 2 is a block diagram illustrating an example configuration of a message transmission and reception system according to various embodiments.

FIG. 3 is a diagram illustrating an example operation of each entity when a message is transmitted by a primary device in a message transmission and reception system according to various embodiments.

FIG. 4 is a diagram illustrating an example operation of each entity when a participant leaves a group chat in a message transmission and reception system according to various embodiments.

FIG. 5 is a diagram illustrating an example structure of folders and objects stored in a message store server according to various embodiments.

FIG. 6 is a diagram illustrating an example of data stored in a session history folder according to various embodiments.

FIG. 7 is a diagram illustrating an example structure of a conversation history folder and a session history folder according to various embodiments.

FIG. 8 is a block diagram illustrating an example configuration of a server device according to various embodiments.

FIG. 9 is a block diagram illustrating an example configuration of an electronic device according to various embodiments.

FIG. 10 is a diagram illustrating an example structure of folders and objects stored in a message store server according to various embodiments.

FIG. 11 is a diagram illustrating an example method of replacing information associated with a group state information object using information associated with a conference information object according to various embodiments.

FIG. 12 is a diagram illustrating an example method of performing processing so that a conference information object is located at the top of a conversation history folder according to various embodiments.

FIG. 13 is a flowchart illustrating an example method of processing a message by a server device according to various embodiments.

FIG. 14 is a diagram illustrating example operation of each entity when file transfer is performed by a primary device in a message transmission and reception system according to various embodiments.

FIG. 15 is a diagram illustrating an example structure of folders and objects stored in a message store server according to various embodiments.

FIG. 16 illustrates an example structure of folders and objects stored in a message store server according to various embodiments.

FIG. 17 is a diagram illustrating an example method of separating a file part from a file transfer object according to various embodiments.

FIG. 18 is a diagram illustrating an example message transmitted and received when a small file is uploaded by a client according to various embodiments.

FIG. 19 is a signal flow diagram illustrating an example operation of a client and a message store server when a large file is uploaded according to various embodiments.

### DETAILED DESCRIPTION

Hereinafter, various example embodiments of the disclosure will be described in greater detail with reference to the drawings. However, the disclosure may be implemented in various different forms and is not limited to embodiments set forth herein. With regard to the description of the drawings, the same or like reference signs may be used to designate the same or like elements. Also, in the drawings and the relevant descriptions, description of well-known functions and configurations may be omitted for the sake of clarity and brevity.

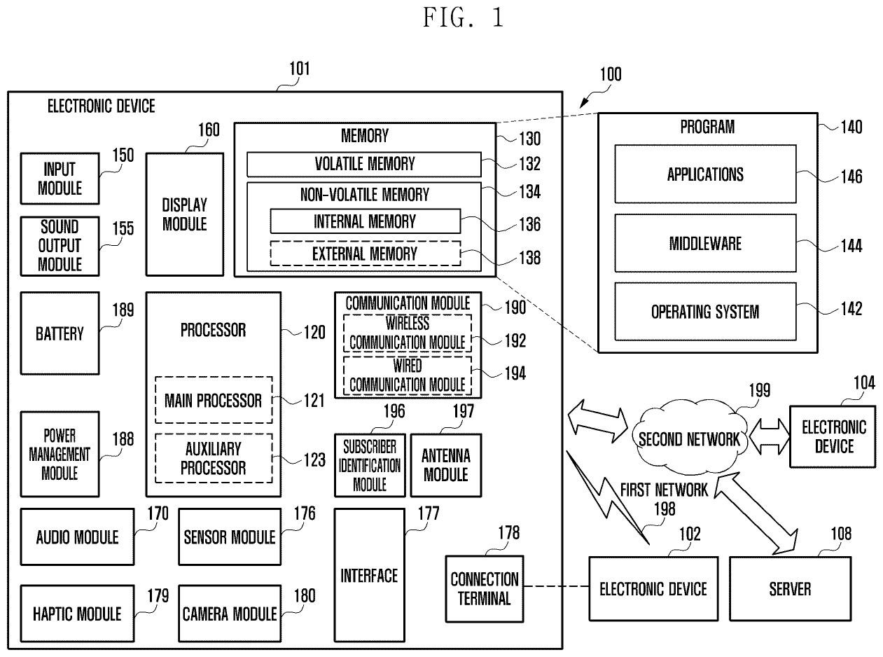

FIG. 1 is a block diagram illustrating an example electronic device in a network environment according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

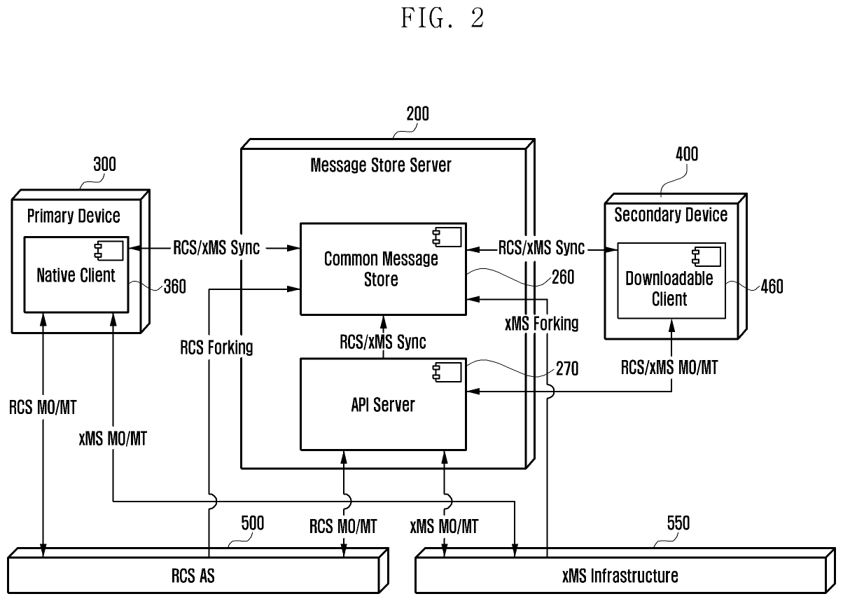

FIG. 2 is a block diagram illustrating an example configuration of a message transmission and reception system according to various embodiments.

Referring to FIG. 2, the message transmission and reception system may include a primary device 300, a secondary device 400, a message store server 200, a rich communication service application server (RCS AS) 500, and an xMS infrastructure 550. Each of the devices may be connected to each other through a network.

According to an embodiment, the primary device 300 and the secondary device 400 may be various types of electronic devices (e.g., electronic device 101 of FIG. 1) used by a user. For example, the primary device 300 and the secondary device 400 may be implemented as a portable communication device (e.g., smartphone or tablet PC), a computing device (e.g., desktop PC or laptop PC), or a wearable device (e.g., smart watch or head-mounted device), but are not limited thereto. In the following description, the primary device 300 and the secondary device 400 may all be referred to as an electronic device. In FIG. 2, the primary device 300 and the secondary device 400 are the same user's devices and use the same or linked identification information (e.g., IMEI, or account), and may be recognized as the same user's devices on a network.

According to an embodiment, the primary device 300 may be a device including a native client 360 supporting a rich communication service (RCS). The primary device 300 may include the native client 360, which is a native version of an RCS-supporting application, and may be installed when the primary device 300 is manufactured and/or when firmware is updated. The primary device 300 may implement a basic message application based on the RCS.

According to an embodiment, the secondary device 400 may not include the native client 360, but may include a downloadable client 460 supporting the RCS. For example, a platform (or operating system) of the secondary device 400 may not support the RCS by default, and the user may download the downloadable client 460 supporting the RCS from an application market, and install and execute the same. According to an embodiment, a plurality of secondary devices corresponding to one primary device 300 may be used.

In the disclosure, the native client 360 may be an entity that transmits and receives an actual message through an RCS AS 500 or the xMS infrastructure 550. In addition, the downloadable client 460 may synchronize and store a message transmitted and received via the native client 360 and provide the same to a user, and may transmit a message via the message store server 200.

According to an embodiment, the RCS AS 500 may be an application server in charge of transmission and reception of an RCS message of a global system for mobile communications association (GSMA) standard. The RCS AS 500 may provide various RCS functions, such as user registration and authentication related to the RCS, message routing, group chat, and/or file transfer.

According to an embodiment, the xMS infrastructure 550 may be an infrastructure in charge of transmission and reception of a 3GPP standard legacy message. In the disclosure, a legacy message service before the RCS, such as Short Message Service (SMS), Multimedia Message Service (MMS), or Long Message Service (LMS), may be referred to as an xMS.

According to an embodiment, an RCS message (or an RCS mobile originated (MO)/mobile terminated (MT)) transmitted and received by the native client 360 of the primary device 300 may be transmitted to and received from another mobile terminal (or a counterpart device) via an RCS AS 500, and a transmitted and received xMS message (or an xMS MO/MT) may be transmitted to and received from another mobile terminal via an xMS infrastructure 550. The downloadable client 460 of the secondary device 400 may be incapable of directly accessing the RCS AS 500 and the xMS infrastructure 550. An RCS message or xMS message transmitted and received by the secondary device 400 may be transmitted to and received from another mobile terminal via the message store server 200 (e.g., the API server 270).

According to an embodiment, the message store server 200 may be a server that provides an open mobile alliance converged IP messaging (OMA CPM) service environment. The message store server 200 may perform various operations, such as routing and storing data related to an RCS message and/or an xMS message. The message store server 200 may provide a message transmitted and received by the native client 360 to the downloadable client 460. In addition, the message store server 200 may transmit a message transmitted from the downloadable client 460 via an actual message server.

According to an embodiment, the message store server 200 may include a common message store 260 and an application programming interface (API) server 270. The common message store 260 may store a message transmitted and received via the message store server 200 by each electronic device (e.g., the primary device 300 or the secondary device 400). The API server 270 may transmit an RCS message transmitted at the request of the downloadable client 460 to another mobile terminal via the RCS AS 500, and/or may transmit an xMS message transmitted at the request to another mobile terminal via the xMS infrastructure 550.

According to an embodiment, when the native client 360 of the primary device 300 transmits an RCS message to another mobile terminal, the RCS message may be transmitted to the RCS AS 500. The RCS AS 500 may fork an RCS message to the common message store 260 of the message store server 200. The message store server 200 may synchronize the RCS message that is forked to the common message store 260 with the downloadable client 460 of the secondary device 400. In addition, when an xMS message is transmitted from the native client 360 to another mobile terminal, the xMS message may be transmitted to the xMS infrastructure 550. The xMS infrastructure 550 may fork an xMS message to the common message store 260 of the message store server 200. The message store server 200 may synchronize the xMS message forked to the common message store 260 with the downloadable client 460 of the secondary device 400.

According to an embodiment, when an RCS message or an xMS message is transmitted from the downloadable client 460 of the secondary device 400 to another mobile terminal, the message may be transmitted to an API server 270 of the message store server 200. The API server 270 may store the received RCS message or xMS message, and may synchronize the stored RCS message or xMS message with the common message store 260. The message store server 200 may synchronize, with the native client 360 of the primary device 300, the stored RCS message or xMS message that is synchronized with the common message store 260.

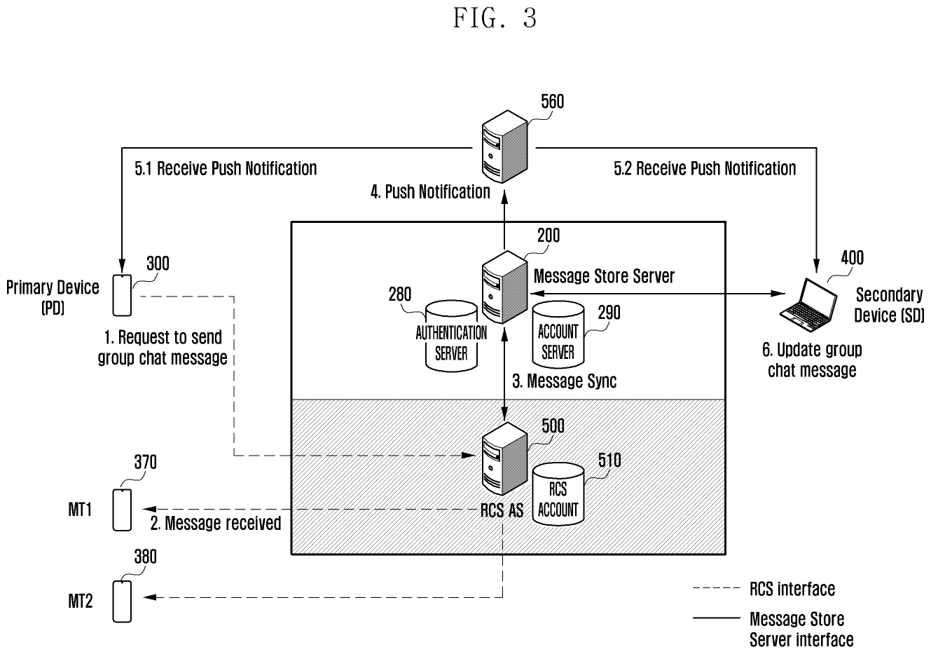

FIG. 3 is a diagram illustrating an example operation of each entity when a message is transmitted by a primary device in a message transmission and reception system according to various embodiments.

In FIG. 3, a primary device 300 is a device that includes a native client (e.g., native client 360 in FIG. 2), and a message requested to be transmitted by a user may be transmitted to a network through the native client. A secondary device (SD) 400 is a device including a downloadable client (e.g., downloadable client 460 in FIG. 2) and is capable of accessing a network via an account of the same user of the primary device 300. A group chat based on rich communication services (RCS) may be provided using the primary device 300, and at least one other mobile terminal (MT1 370 or MT2 380) including an RCS native client may participate in the group chat.

According to an embodiment, the message store server 200 may perform various operations such as routing and storing data related to an RCS message. For example, the message store server 200 may perform various operations to synchronize messages transmitted and received by the primary device 300 with the secondary device 400. The message store server 200 may communicate with an authentication server 280 that performs authentication of a user (e.g., a sender or a receiver) of an RCS message and an account server 290 that manages account information of a user.

According to an embodiment, the primary device 300 may generate a message to be transmitted in a group chat, based on a user input. The primary device 300 may transmit the generated group chat message to an RCS AS 500. The native client of the primary device 300 may transmit a group chat message using an RCS scheme.

According to an embodiment, the RCS AS 500 may transmit a group chat message transmitted from the primary device 300 to other mobile terminals MT1 370 and MT2 380. An interface between the RCS AS 500 and the primary device 300 or other mobile terminals MT1 370 and MT2 380 may be configured as an RCS interface, and the primary device 300 and other mobile terminals MT1 370 and MT2 380 may access the RCS AS 500 using an RCS account 510.

According to an embodiment, the RCS AS 500 may transmit a group chat message transmitted from the primary device 300 to the message store server 200. For example, the RCS AS 500 may fork a group chat RCS message to a common message store (e.g., common message store 260 of FIG. 2) of the message store server 200.

According to an embodiment, the message store server 200 may identify a connected client from a received group chat message. For example, the message store server 200 may identify at least one client (e.g., native client and/or downloadable client) that accesses a sender's account or receiver's account via communication with the account server 290 using the account information of participants of the group chat.

According to an embodiment, the message store server 200 may transmit a push message (or push notification) to a push server 560 so as to transmit the push message (or push notification) a device of the identified client. In this case, the message store server 200 may provide, to the push server 560, information associated with a recipient of the push message (e.g., account, IMEI, and/or IP address), and the push server 560 may transmit the push message to the recipient's client. For example, the message store server 200 may transmit a push message to the primary device 300 and the secondary device 400 including a client that accesses the sender's account of the group chat message, via the push server 560. The push message may include information such as a group chat ID, a sender, and/or a path (e.g., URL) through which a message may be obtained.

According to an embodiment, in the case in which the primary device 300 receives a push message, the primary device 300 may identify that the push message is related to a group chat message transmitted by the primary device 300. The primary device 300 may not perform a separate operation in response to reception of the push message, since an update is caused due to the group chat message transmitted by itself.

According to an embodiment, when a push message is received, the secondary device 400 may identify a group chat message from the message store server 200 using information included in the push message. For example, the push message may include URL information for acquiring a group chat message, and the secondary device 400 may access the message store server 200 using the corresponding URL information to acquire the group chat message.

According to an embodiment, the secondary device 400 may store the acquired group chat message and update a UI of the message application.

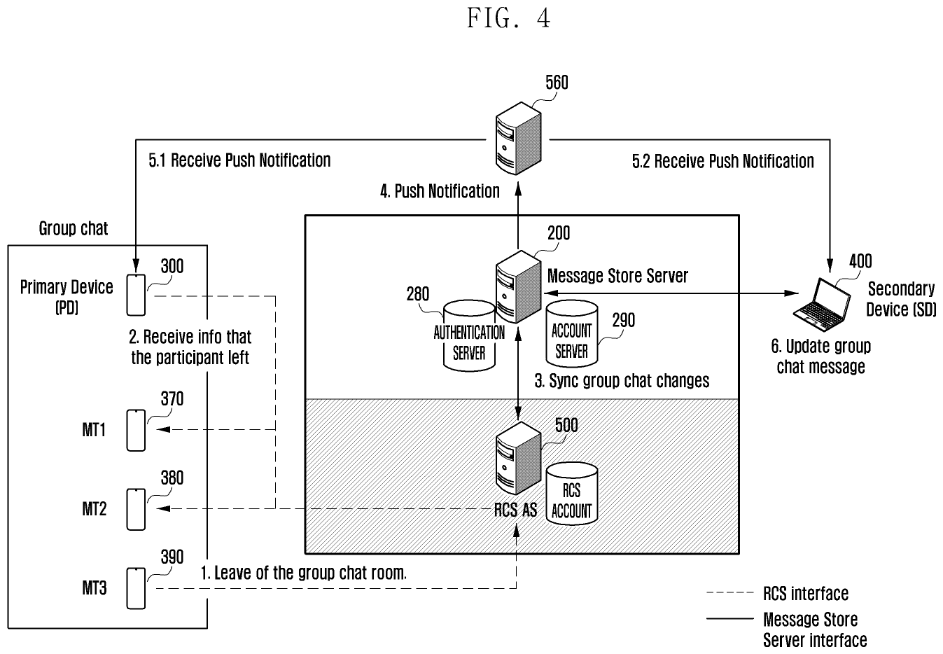

FIG. 4 is a diagram illustrating example operation of each entity when a participant leaves a group chat in a message transmission and reception system according to various embodiments.

According to an embodiment, the message store server 200 may, in response to an event occurring in a group chat, transmit information corresponding to the event to a client of a participant of the group chat. Here, the event is a change associated with a participant of the group chat, and for example, the event may include an event in which a new participant joins the group chat or an event in which a participant leaves the group chat.

Referring to FIG. 4, it may be a situation in which MT3 390 leaves a group chat when the primary device 300 and three other mobile terminals (hereinafter, MT1 370, MT2 380, and MT3 390) participate in and generate the group chat. Here, the primary device 300, MT1 370, MT2 380, and MT3 390 may be devices including native clients supporting an RCS (e.g., native client 360 of FIG. 2). The secondary device 400 may include a downloadable client (e.g., downloadable client 460 of FIG. 2) and may be a device that accesses using an account of the same user of the primary device 300.

According to an embodiment, when MT3 390 leaves the group chat, MT3 390 may transmit information related to an event of leaving the group chat to RCS AS 500. The RCS AS 500 may transmit information related to the event to the clients of the participants (e.g., primary device 300, MT1 370, and MT2 380) of the group chat. For example, the RCS AS 500 may transmit information including a change in the group chat to the primary device 300, MT1 370, and MT2 380 via an RCS interface.

According to an embodiment, the RCS AS 500 may transfer the change in the group chat, which are caused as MT3 390 leaves the group chat, to the message store server 200.

According to an embodiment, the message store server 200 may transmit a push message (or push notification) to the push server 560 so as to transfer the push message (or push notification) in association with the change to a connected client. In this case, the message store server 200 may provide, to the push server 560, a recipient's information (e.g., account, IMEI, and/or IP address) of the push message, and the push server 560 may transmit the push message to the recipient's client (e.g., native client and/or downloadable client).

According to an embodiment, when the primary device 300 receives a push message, the primary device 300 may identify that the information delivered via the RCS AS 500 is the same as the received push message, and may not perform a separate operation in response to the reception of the push message.

According to an embodiment, in the case in which the secondary device 400 receives a push message, the secondary device 400 may obtain information on the corresponding change from the message store server 200 using information included in the push message. The secondary device 400 may store information acquired from the message store server 200 and update an UI of a message application.

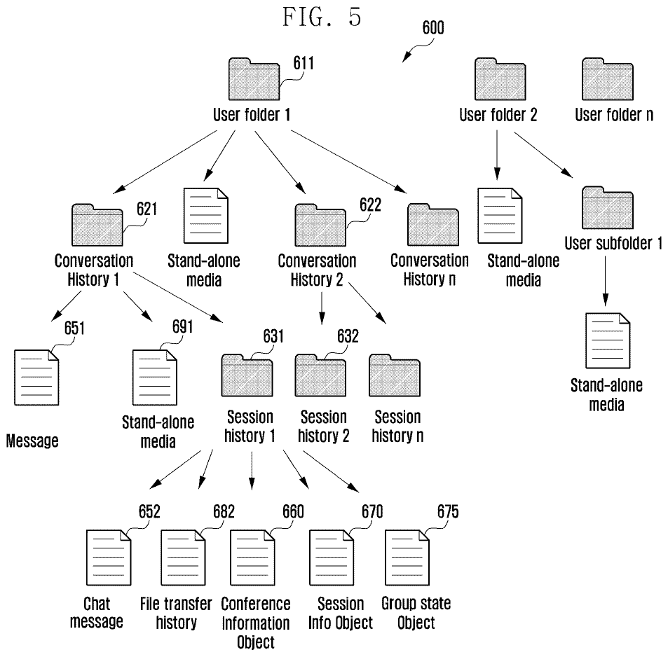

FIG. 5 is a diagram 600 illustrating an example structure of folders and objects stored in a message store server according to various embodiments.

According to an embodiment, a message store server (e.g., the message store server 200 in FIGS. 2 to 4) may be a server that provides an open mobile alliance converged IP messaging (OMA CPM) service environment. The message store server may store information related to an RCS or xMS (e.g., SMS, MMS, or LMS) message based on a designated format. FIG. 5 illustrates a hierarchical structure of a user folder storage model stored in the message store server.

According to an embodiment, a user folder 611 may be a root folder of each user. For example, information related to messages transmitted and received by one or more clients using the same account may be stored under the user folder 611.

According to an embodiment, a conversation history folder 621 or 622 may be stored under the user folder 611 and may be a folder for storing information associated with each chat room which a corresponding user belongs to. The conversation history folder 621 or 622 may be separately generated for each 1:1 chat or group chat which the user belongs to. For example, the conversation history folder 621 of each 1:1 chat to which the user belongs and the conversation history folder 622 of a group chat may be generated, and an object related to a message exchanged in the corresponding chat room may be stored in the conversation history folders 621 and 622.

According to an embodiment, a message object 651 and a stand-alone media object 691 may be stored under the conversation history folder 621. The objects stored not under a session history folder 631 or 632 but directly under the conversation history folder 621 may be objects related to a legacy message service (or xMS) message.

According to an embodiment, the session history folder 631 or 632 may be a folder for storing information related to a message transmitted and received in each session in a single chat room. For example, in the case in which a predetermined user generates a 1:1 chat room with another user or a group chat room with multiple other users, a session may be generated between clients participating in the chat room. The session may be terminated when a predetermined time elapses, when no message is transmitted during a predetermined time, and/or when no event occurs in the chat room. That is, one chat room may configure at least one session from generation to termination, and information related to a message transmitted and received in each session may be stored respectively under the corresponding session history folder.

According to an embodiment, objects related to an RCS-based message may be stored under the session history folder 631. For example, the session history folder 631 may store a message object 652 related to a message transmitted and received in each session, a file transfer history object 682, a conference information object 660, a session information object (session history object) 670, and/or a group state object 675.

According to an embodiment, the message object 652 may include a multipurpose internet mail extensions (MIME) object including a header attribute (or metadata) such as a content type identifying a format and a type of a message, as a basic object defined in CPM. The message object 652 may include information associated with a message actually exchanged between clients. For example, the message object 652 may include information such as sender and recipient information, time information, a subject, a conversation ID, a contribution ID, a P-asserted-service, an IMDN-message-ID, and a content type.

According to an embodiment, the file transfer history object 682 may be an object including information related to a file transmitted and received between clients.

According to an embodiment, the group state object 675 may be an object including information related to a group chat. For example, the group state object 675 may include information related to a group chat, such as a subject of the group chat, a max user count, a policy, or a participant name. The group state object 675 may include information associated with a MIME header defined in the message object 652.

According to an embodiment, the conference information object 660 may be an object including information related to a change in a group chat. For example, the conference information object 660 may include at least one of a session ID, a timestamp, a group type, participant information, a subject, an icon, the maximum number of users, and session information.

According to an embodiment, the session information object 670 may be an object including information related to a session of a chat room. The session information object 670 may maintain and manage information related to a state of an individual session, and may include a session information change value of each message.

According to an embodiment, the message store server may record conversation information using a component (e.g., folder and object) determined based on a message service type. For example, when a 1:1 chat or group chat is based on a legacy message service (e.g., SMS, MMS), the conversation history folder 621 among the components illustrated in FIG. 5 (e.g., folders and objects) may be generated, and the message object 651 and the stand-alone media object 691 stored in the conversation history folder 621 may be used. In addition, in a 1:1 chat or group chat based on the RCS, session history folders 631 and 632 corresponding to respective sessions may be generated under the conversation history folder 621. The group state object 675 related to an RCS message, the conference information object 660, the session information object 670, the message object 652, and the file transfer history object 682 may be stored in the session history folder 631.

The information included in each object described above may correspond to an embodiment, and the information included in each object is not limited to the example described above.

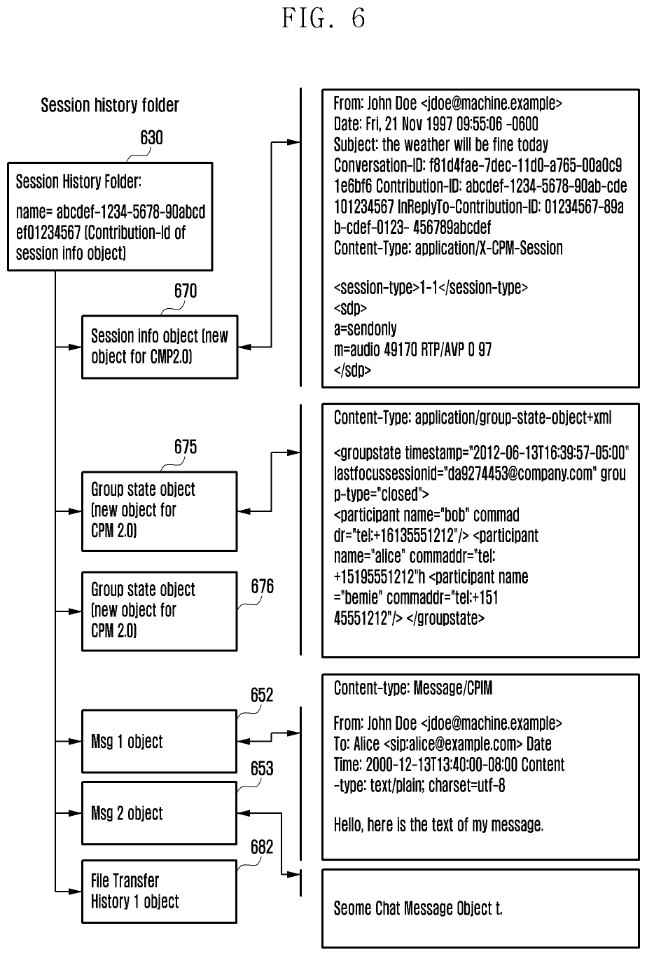

FIG. 6 is a diagram illustrating an example of data stored in a session history folder according to various embodiments.

According to an embodiment, a session history folder 630 may be stored under a conversation history folder corresponding to a predetermined chat room, and may be generated for each session. For example, when a predetermined user generates a 1:1 chat room with another user or a group chat room with multiple other users, a session may be generated between the clients participating in the chat room. The session may be terminated when a predetermined time elapses, no message is transmitted during a predetermined time, and/or no event occurs in the chat room.

Referring to FIG. 6, the session history folder 630 may store the session information object 670, the group state object 675 or 676, the message object 652 or 653, and the file transfer history object 682.

According to an embodiment, a name of the session history folder 630 may be determined based on a contribution ID of the session information object 670.

According to an embodiment, the session information object 670 may store information related to a sender of a message, a time, a subject, a conversation ID, a contribution ID, and/or a content type. The group state object 675 or 676 may store participant information of a group chat.

According to an embodiment, the message object 652 or 653 may include information associated with a message actually exchanged between clients. The file transfer history object 682 may include information related to a file transmitted from a predetermined client.

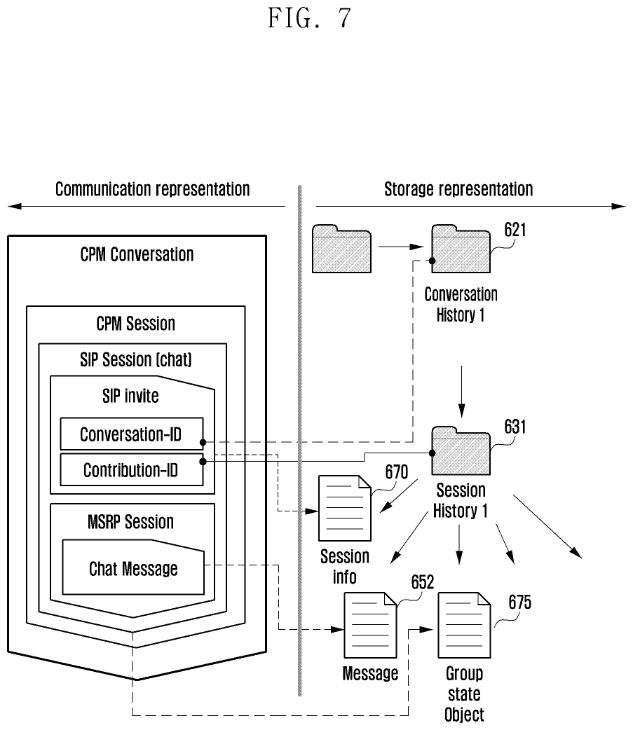

FIG. 7 is a diagram illustrating an example structure of a conversation history folder and a session history folder according to various embodiments.

According to an embodiment, when a group chat including an electronic device is initiated, a chat room of the group chat may be generated, and data transmitted and received inside the corresponding chat room may be stored in the conversation history folder 621. The conversation history folder 621 may be stored under a user folder.

According to an embodiment, each chat room may be configured with at least one CPM session. For example, when a predetermined user generates a 1:1 chat room with another user or a group chat room with multiple other users, a CPM session may be generated between clients participating in the chat room. The CPM session may be terminated when a predetermined time elapses, when no message is transmitted for a predetermined time, and/or when no event occurs in the chat room.

According to an embodiment, the CPM session may include a session initiation protocol (SIP) session. Attribute information defined in the SIP session may be stored in the group state object 675.

According to an embodiment, the SIP session may include an SIP invite session and a message session relay protocol (MSRP) session as a sub-session. The SIP invite session may be used to establish and control a connection between users when a group chat is initiated using SIP. MSRP is a protocol for real-time messaging service, and the MSRP session may be used for a message exchanged in real time between participants of a group chat.

According to an embodiment, for the SIP invite session, a conversation ID and a contribution ID may be defined. According to an embodiment, the conversation history folder 621 may include a conversation ID, and the session history folder 631 may include a contribution ID. For example, a name of the session history folder 631 may include a contribution ID of a corresponding SIP session.

According to an embodiment, a message transmitted by a group chat participant may be transmitted via the MSRP session, and information associated with the transmitted message may be generated as the message object 652 and stored under the session history folder 631.

According to the folder and object storage structure described with reference to FIGS. 5 to 7, various types of folders and objects may be used to synchronize group chat messages. Therefore, the structure of server and client sides may be complicated, and the implementation may be difficult. In addition, since a large number of folders and objects are generated during one message transmission and reception, a transaction may frequently occur between servers for object generation or between a server and a client. In addition, at initial synchronization, a client may operate so as to generate an object and upload the same to a server. In this case, the number of objects to be generated to process each message may be increased, and there is a problem in that the client always needs to store data required to generate the object.

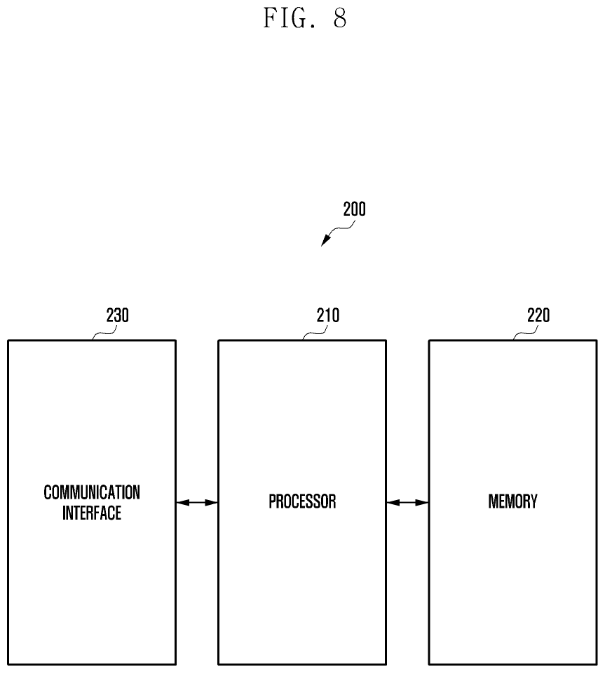

In the following description, various example embodiments that may be implemented with a simple structure and that may reduce transactions and stored data by only using objects and folders having information essential for performing a group chat synchronization function, will be described in greater detail with reference to FIGS. 8 to 13.

FIG. 8 is a block diagram illustrating an example configuration of a server device according to various embodiments.

Referring to FIG. 8, the server device 200 according to an embodiment may include a communication interface (e.g., including communication circuitry) 230, a processor (e.g., including processing circuitry) 210, and a memory 220. Although some of the illustrated components are omitted or replaced, various embodiments of the disclosure may be implemented. At least some of the components of the illustrated (or not illustrated) server device 200 may be operatively, functionally, and/or electrically connected to each other.

According to an embodiment, the server device 200 may be a message store server (e.g., message store server 200 in FIGS. 2 to 4) that provides an open mobile alliance converged IP messaging (OMA CPM) service environment.

According to an embodiment, the communication interface 230 may include various communication circuitry and support communication with various electronic devices via a network. The communication interface 230 may provide various interfaces such as a hypertext transfer protocol (HTTP), a representational state transfer (REST), a message queuing telemetry transport (MQTT), or a socket. The server device 200 may communicate with clients (e.g., primary device 300 and secondary device 400 in FIG. 2) and/or servers (e.g., RCS AS 500 and push server 560 in FIG. 2) on a network via the communication interface 230.

According to an embodiment, the memory 220 may store various data either temporarily or non-temporarily. The memory 220 may include various types of memory 220, such as a random access memory (RAM), virtual memory, cache memory, and/or flash memory.

According to an embodiment, the processor 210 may be a configuration that may include various processing circuitry and perform operations or data processing regarding control and/or communication of the components of the server device 200, and may include one or more processors. Operations and data processing that may be implemented by the processor 120 in the server device 200 may not be limited, but the description below will focus on various embodiments of synchronizing an event that occurs in a group chat in electronic devices (e.g., a primary device and a secondary device). The operations of the processor 210 described below may be performed by loading the instructions stored in the memory 220. The description of the processor 120 above with reference to FIG. 1 applies equally to the processor 210 and therefore, a repeated description may not be provided here.

In the disclosure, a description explaining that the processor 210 (or server device 200) may perform a predetermined operation (or function, operation, or task) may be understood as substantially the same as a description explaining that instructions (or commands or computer programs) causing the server device 200 (or the processor 210) to perform the operation are stored in the memory 220 (e.g., non-volatile memory or storage). The description explaining that the processor 210 may perform a predetermined operation may be understood as substantially the same as a description explaining that at least one processor, which is not limited to a specific one, may perform the operation.

According to an embodiment, the processor 210 may identify that a group chat of a group including a first electronic device (or primary device) is initiated. Here, the group chat may be a group chat in which messages may be transmitted and received between multiple participants based on a rich communication service (RCS). The first electronic device may be a primary device (e.g., primary device 300 in FIGS. 2 to 4) including a native client. For example, a native client may be a native version of an application supporting the RCS, and may be installed when a primary device is manufactured and/or when firmware is updated. The first electronic device may implement a basic message application based on the RCS.

According to an embodiment, a user of the first electronic device may also use the group chat via a second electronic device using the same account. Here, the second electronic device may be a secondary device (e.g., secondary device of FIGS. 2 to 4) that does not include a native client and includes a downloadable client supporting the RCS. The second electronic device may operate as a platform (or operating system) different from that of the first electronic device.

According to an embodiment, when a group chat including the first electronic device is initiated, the processor 210 may generate a conversation history folder including data related to the group chat, and store the same in the memory 220. The conversation history folder may be stored under a user folder, and may be a folder for storing information associated with each chat room which the corresponding user belongs to. For example, the processor 210 may generate a user folder that is a root folder for a user account of the first electronic device, and may generate, under the user folder, a conversation history folder corresponding to each chat room which the first electronic device belongs to. The conversation history folder may be generated for each 1:1 chat and group chat.

According to an embodiment, the processor 210 may store, in the conversation history folder, objects including information on events occurring during a plurality of session periods generated in a group chat. For example, the conversation history folder may store a message object, a conference information object, and a file transfer history object.

According to an embodiment, the processor 210 may not generate a session history folder corresponding to each session under the conversation history folder, but may directly store all objects under the conversation history folder. For example, when a group chat room is generated, a session may be generated between clients who participates in the chat room, and the session may be terminated when a predetermined time elapses, no message is transmitted during a predetermined time, and/or no event occurs in the chat room. In the example of FIG. 5, the objects generated in each session are stored under a session history folder corresponding to each session, but the server device 200 according to an embodiment may store all the objects under the conversation history folder, without distinguishing session history folders of sessions when storing the objects.

According to an embodiment, in response to occurrence of an event related to a group chat, the processor 210 may generate a conference information object including information associated with the event that occurs. Here, the group chat-related event may include various events occurring in the group chat, such as transmission of a message from a predetermined participant, a case in which a participant leaves the chat room, or a case in which a new participant joins the chat room.

According to an embodiment, the conference information object may be an object including information related to a change in the group chat. For example, the conference information object may include at least one of a session ID, a timestamp, a group type, participant information, a subject, an icon, the maximum number of users, and session information.

Table 1 shows an example of attribute information included in a conference information object.

TABLE 1

| Attribute | | | Type | Description |
|---|---|---|---|---|
| message context | | | String | Information about the |
| | | | | context and character- |
| | | | | istics of a message |
| contribution-ID | | | String | The entity that stores |
| | | | | the message. |
| timestamp | | | String | The time when the change |
| | | | | was made. Nanoseconds |
| entity | | | String | Group chat session ID |
| conference- | subject | | String | Unique ID |
| description | subject-ext | timestamp | String | The time when the change |
| | | | | was made |
| | | participant | String | The participant that made |
| | | | | the change |
| | icon | icon-uri | String | URL pointing to the image |
| | | file-info | IconFileInfo | Icon File Information |
| | | timestamp | String | The time when the change |
| | | | | was made |
| | | participant | String | The participant that made |
| | | | | the change |
| | maximum-user-count | | Int | Maximum number of |
| | | | | participants allowed |
| | policy | | list of string | CPM Controlling Function |
| | | | | Policy |
| users | User | entity | String | URI for the user in the |
| | | | | conference |
| | | display-text | String | Display text |
| | | yourown | Boolean | The CPM User to which the |
| | | | | conference info object is |
| | | | | sent |
| | | roles | String | User roles |

| | | | |
|---|---|---|---|
| endpoint | entity | String | Entity key for each endpoint |
| | status | String | “connected”, |
| | | | “disconnected” |

According to an embodiment, the processor 210 may include, in the conference information object, information corresponding to at least one attribute information included in a group state object and a session information object. Here, the group state object may be an object including information related to a change in a group chat, such as a subject of the group chat, a maximum user count, a policy, or a name of a participant. The session information object may be an object including a session information change value of each message.

Table 2 illustrates an example of attribute information included in a group state object.

TABLE 2

| Attribute | | | Type | Description |
|---|---|---|---|---|
| lastfocussessionid | | | anyURI | CPM Group Session |
| | | | | Identity, |
| timestamp | | | dateTime | Time when the event |
| | | | | occurred |
| group-type | | | String | type of CPM Group |
| | | | | Session |
| iw-number | | | anyURI | the unique interworking |
| | | | | number |
| status | | | | CPM User's status |
| | removed | | participant | CPM User has been |
| | | | | removed |
| participant | | | | participant information |
| | name | | String | current participant |
| | comm-addr | | anyURI | communication address |
| | yourown | | String | current user own |
| | role | | String | role of the CPM User |
| subject | | | | Group chat subject |
| | text | | String | the subject data |
| | participant | | participant | Participant that has |
| | | | | made the change |
| | timestamp | | dateTime | the date and time when |
| | | | | the change |
| icon | | | | icon information |
| | source | | | icon source information |
| | | icon-uri | anyURI | URI pointing to the icon |
| | | | | image |
| | | file-info | String | content-ID of the icon |
| | | | | image |

| | | |
|---|---|---|
| participant | participant | Participant that has |
| | | made the change |
| timestamp | dateTime | the date and time when |
| | | the change |

| | | |
|---|---|---|
| max-user-count | unsignedInt | the maximum of users |
| policy | string | the CPM Controlling |
| | | Function Policy |

Table 3 shows an example of attribute information included in a session information object.

TABLE 3

| Attribute | | Type | Description |
|---|---|---|---|
| session | | | session information |
| | session-type | String | type of CPM Session. |
| | session-replaces | String | Contribution-ID |
| | invited-participants | participant | list of addresses the |
| | | | invited participants |

According to an embodiment, the processor 210 may not generate a group state object and a session information object when an event occurs in a group chat, and may store information corresponding to the event using a conference information object. The conference information object may include information corresponding to attribute information included in the group state object and the session information object, and may store information associated with an event that occurs in a group chat using attribute information defined in the conference information object, without generating the group state object and the session information object.

Table 4 shows attribute information of a group state object and attribute information of a conference information object which is capable of replacing the same, by matching them.

TABLE 4

| | |
|---|---|
| Attribute | replace method |

| lastfocussessionid | | Entity |
|---|---|---|
| timestamp | | Timestamp |
| group-type | | message context |
| iw-number | | the entity of the yourown |
| | | is true. |
| | status | |

| | |
|---|---|
| removed | User > endpoint > status |

participant

| | |
|---|---|
| name | User > display-text |
| comm-addr | User > entity |
| yourown | User > yourown |
| role | User > roles |

subject

| | |
|---|---|
| text | conference-description > |
| | subject |
| participant | conference-description > |
| | subject-ext > participant |
| timestamp | conference-description > |
| | subject-ext > timestamp |

| | | | |
|---|---|---|---|
| icon | | | |
| | source | | |
| | | icon-uri | conference-description > |
| | | | icon > icon-uri |
| | | file-info | conference-description > |
| | | | icon > file-info |

| | |
|---|---|
| participant | conference-description > |
| | participant |
| timestamp | conference-description > |
| | timestamp |

| | |
|---|---|
| max-user-count | conference-description > |
| | maximum-user-count |
| policy | conference-description > |
| | policy |

Table 5 shows attribute information of a session information object and attribute information of a conference information object that is capable of replacing the same, by matching the same.

TABLE 5

| | |
|---|---|
| Attribute | replace method |

| | | |
|---|---|---|
| session | | |
| | session-type | message context |
| | session-replaces | Contribution-ID |
| | invited-participants | Users |

For example, when a specific participant leaves a group chat room, this may be recorded by adding a removed item to a status attribute of the group state object. In addition, when the predetermined participant leaves the group chat room, the status of the removed participant in the conference information object may be changed to disconnected. Alternatively, when a previous status of the corresponding participant is connected, the participant may be processed as being removed. The processor 210 may store information regarding the same event using only the conference information object, without using the group state object.

According to an embodiment, when an event occurs in a group chat, the processor 210 may generate a conference information object including all predefined attribute information. That is, the processor 210 may store the conference information object in a full notify form including all attribute information, not only including information changed in response to an event occurrence.

According to an embodiment, the server device 200 may include a time to live (TTL) indicating a validity period of data with regard to storage of the data. The server device 200 may delete an object when a predetermined time elapses after the object is generated and stored. Accordingly, in the case of applying the TTL as it is, a synchronization operation may be unavailable with regard to a group chat after the TTL period elapses from the generation of the group chat. Therefore, the processor 210 may not delete a conference information object most recently generated in each group chat, although the TTL period elapses. The processor 210 may be configured to, when a new conference information object is generated as an event occurs in a group chat, store the generated conference information object at the top of a conversation history folder (or as the most recently generated one). The conference information object stored at the top of the conversation history folder is not deleted even after the TTL period elapses, and a client (e.g., second electronic device) is configured to identify objects in the order of most recently generated objects when obtaining the information associated with the group chat for the first time, and may obtain the most recently generated conference information object stored at the top of the conversation history folder.

According to an embodiment, the processor 210 may transmit the generated conference information object to the second electronic device via the communication interface 230. For example, the server device 200 may transmit a push message corresponding to occurrence of an event to the first electronic device and the second electronic device via a push server. The first electronic device including an RCS native client may acquire event information via another server (e.g., RCS AS 500 in FIGS. 2 to 4), and thus may not perform an operation corresponding to reception of the push message. The second electronic device that does not include a native client may, in response to reception of the push message, access the server device 200 using a path included in the push message, and may obtain a conference information object stored in the memory 220 of the server device 200.

According to an embodiment, the second electronic device may acquire the conference information object from the server device 200, and update information associated with a group chat therefrom. The second electronic device may apply an event-related content to a group chat-related UI.

Instructions for performing the above-described operations of the server device 200 (or the processor 210) may be stored in a computer-readable recording medium. The recording medium may be tangible and non-transitory. The recording medium may store one or more computer programs including the instructions.

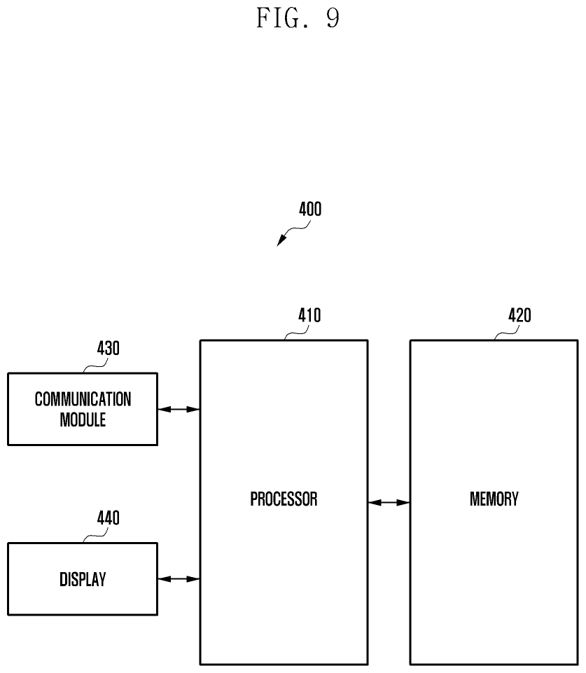

FIG. 9 is a block diagram illustrating an example configuration of an electronic device according to various embodiments.

Referring to FIG. 9, an electronic device 400 according to an embodiment may include a display 440, a communication module (e.g., including communication circuitry) 430, a processor (e.g., including processing circuitry) 410, and a memory 420. Although some of the illustrated components are omitted or replaced with other components, various embodiments of the disclosure may be implemented. In addition to the illustrated components, the electronic device 400 may further include at least a portion of the components and/or functions of the electronic device 101 of FIG. 1. At least a portion of the illustrated (or not illustrated) components of the electronic device 400 may be operatively, functionally, and/or electrically connected to each other.

According to an embodiment, the electronic device 400 may be a secondary device 400 in FIGS. 2 to 4. For example, the electronic device 400 may not include a native client, and may include a downloadable client supporting an RCS. For example, a platform (or operating system) of the secondary device does not support the RCS by default, and a user may download and install a downloadable client supporting the RCS from an application market, and execute the same. The electronic device 400 may acquire information related to a group chat via a message server (e.g., message store server 200 in FIGS. 2 to 4, server device 200 in FIG. 8).

According to an embodiment, as a device of the same user of another electronic device (e.g., primary device 300 in FIGS. 2 and 4), the electronic device 400 may access a group chat service using the same account. For example, when another electronic device participates in a group chat and transmits a message, the electronic device 400 may acquire the corresponding event information from the message server and update the group chat information.

According to an embodiment, the display 440 may be implemented as any one of a liquid crystal display (LCD), a light-emitting diode (LED) display, and an organic light-emitting diode (OLED) display, but is not limited thereto. The display 440 may be configured as a touch screen capable of detecting a touch and/or proximity touch (or hovering) input provided using a user's body part (e.g., finger) or an input device (e.g., stylus pen). The display 440 may include at least a portion of the components and/or functions of the display module 160 of FIG. 1.

According to an embodiment, the communication module 430 may include various hardware (e.g., communication circuitry) and/or software configurations for supporting wireless communication with an external device (e.g., server device 200 of FIG. 8). The communication module 430 may support short-range wireless communication (e.g., Wi-Fi or Bluetooth) and cellular wireless communication (e.g., 4G LTE or 5G NR). The communication module 430 may include at least a portion of the components and/or functions of the communication module 190 of FIG. 1.

According to an embodiment, the memory 420 may include a volatile memory and a non-volatile memory, and may store various data temporarily or permanently. The memory 420 may include at least a portion of the components and/or functions of the memory 130 of FIG. 1, and may store at least a portion of the program 140 of FIG. 1.

According to an embodiment, the memory 420 may store various instructions executable by the processor 410. The instructions may include control commands, such as arithmetic and logic operation, data transfer, input and output, and the like, which may be recognized by the processor 410.

According to an embodiment, the processor 410 may be a configuration that may include various processing circuitry and perform operations or data processing regarding control and/or communication of the components of the electronic device 400, and may be configured with one or more processors 410. The processor 410 may be electrically, functionally, and/or operatively connected to each component of the electronic device 400 including the display 440, the communication module 430, and the memory 420. The processor 410 may include at least a portion of the components and/or functions of the processor 120 of FIG. 1. It will be understood that the description of the processor 120 above with reference to FIG. 1 and the processor 210 of FIG. 8 applies equally to the processor 410 and therefore, a repeated/redundant description thereof may not be provided here.

According to an embodiment, operations and data processing that may be implemented by the processor 410 in the electronic device 400 may not be limited, but the following description will focus on various embodiments of receiving event information related to a group chat from an external message server, and updating group chat information based thereon. The operations of the processor 410 described below may be performed by loading instructions stored in the memory 420.

In the disclosure, a description explaining that the processor 410 (or electronic device 400) is capable of performing a predetermined operation (or function, operation, task) may be understood as substantially the same as a description explaining that instructions (or commands, computer programs) for causing the electronic device 400 (or processor 410) to perform the operation are stored in the memory 420 (e.g., non-volatile memory or the storage). In the description that the processor 410 is capable of performing a predetermined operation may be understood as substantially the same as a meaning saying that at least one processor, which is not limited to a specific one, is capable of performing the operation.

According to an embodiment, the processor 410 may execute a group chat function using a client stored in the memory 420. The electronic device 400 may download and install a downloadable client supporting the RCS from an application market and execute the same. The processor 410 may display, via the display 440, a user interface (UI) representing a group chat.

According to an embodiment, from an external message server (e.g., message store server 200 in FIGS. 2 to 4, and server device 200 in FIG. 8) via the communication module 430, the processor 410 may acquire a conference information object generated as an event related to a group chat occurs. According to an embodiment, in response to occurrence of an event related to a group chat (e.g., message transmission or participant change), the message server may generate a conference information object including information on the event that occurs. The conference information object may include at least one attribute information included in a group state object and a session information object, for example, at least one of a session ID, a timestamp, a group type, participant information, a subject, an icon, the maximum number of users, and session information. The message server may store information on an event that occurs in a group chat using the attribute information defined in the conference information object, without generating a group state object and a session information object.

According to an embodiment, the processor 410 may receive a push message corresponding to an event from a push server (e.g., push server 560 of FIG. 4), and may access the message server using information (e.g., URL) included in the push message and obtain a conference information object.

According to an embodiment, the message server may store a generated conference information object at the top of a conversation history folder, and the electronic device 400 may obtain the conference information object stored at the top of the conversation history folder, that is, the most recently stored conference information object.

According to an embodiment, based on the acquired conference information object, the processor 410 may update information associated with a group chat. The processor 410 may compare previously stored group chat information with information associated with the conference information object, and may update the group chat information.

For example, a message transmitted from a primary device may be recorded via a client, or may change participant information when a participant leaves a chat room or a new participant joins the chat room.

According to an embodiment, the processor 410 may display the updated group chat information on the display 440. The processor 410 may change the updated information in the group chat UI.

The instructions for performing the above-described operations of the electronic device 400 (or processor 410) may be stored in a computer-readable recording medium. The recording medium may be tangible and non-transitory. The recording medium may store one or more computer programs including the instructions.

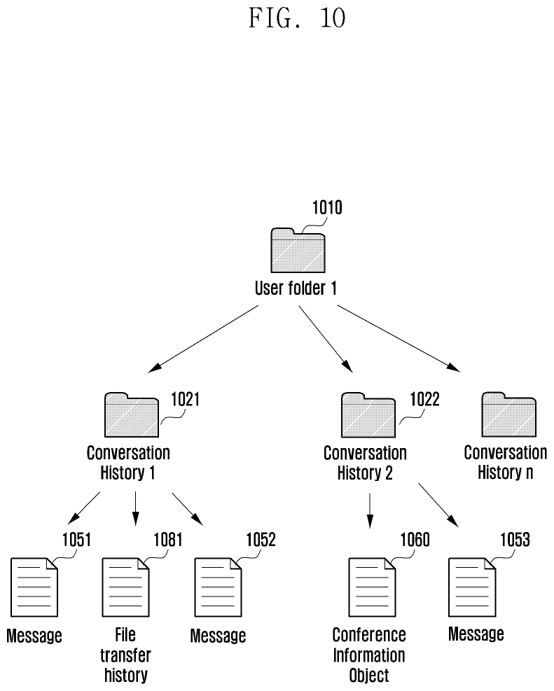

FIG. 10 is a diagram illustrating an example structure of folders and objects stored in a message store server according to various embodiments.

According to an embodiment, the message store server may be a server that provides an open mobile alliance (OMA) converged IP messaging (OMA CPM) service environment. The message store server may store information related to an RCS or xMS (e.g., SMS, MMS, or LMS) message based on a designated format. FIG. 10 illustrates a hierarchical structure of a user folder storage model stored in a message store server (e.g., message store server 200 of FIG. 2, server device 200 of FIG. 8), which is different from the structure of FIG. 5 in some aspects.

According to an embodiment, the message store server may generate a user folder 1010 corresponding to each user who participates in a group chat. The user folder 1010 may be a root folder of each user, and information related to messages transmitted and received via one or more clients using the same account may be stored under the user folder 1010. According to an embodiment, at least one conversation history folder 1021 or 1022 for storing information associated with each chat room to which the corresponding user belongs may be stored under the user folder 1010. A conversation history folder may be generated for each 1:1 chat or group chat to which the user belongs. For example, in the case in which the user is in a state of being a member of one 1:1 chat and one group chat, the conversation history folder 1021 for the 1:1 chat and the conversation history folder 1022 for the group chat may be generated, and objects related to messages exchanged in the corresponding chat rooms may be stored in the conversation history folders 1021 and 1022.

According to an embodiment, message objects 1051 and 1052 generated in 1:1 chat and a file transfer history object 1081 may be stored under the first conversation history folder 1021. The message objects 1051 and 1052 may include information on actually exchanged messages, and a message object may be generated for each message transmitted by each user in the group chat. For example, the message object 1051 may store information associated with a first message transmitted (or received) by the user, and the message object 1052 may store information associated with a second message transmitted (or received) by the user later. The file transfer history object 1081 may include information on files transmitted and received.

According to an embodiment, under the second conversation history folder 1022, a message object 1053 generated in the group chat and a conference information object 1060 may be stored.

According to an embodiment, in response to occurrence of an event related to the group chat, the message store server may generate the conference information object 1060 including information on the event that occurs. Here, the group chat-related event may include various events occurring in the group chat, such as transmission of a message from a predetermined participant, a case in which a participant leaves the chat room, or a case in which a new participant joins the chat room. The conference information object 1060 may be an object including information related to a change in the group chat. For example, the conference information object 1060 may include at least one of a session ID, a timestamp, a group type, participant information, a subject, an icon, the maximum number of users, and session information.

Compared to the structure of FIG. 5, the message store server may not generate a session history folder (e.g., the session history folders 631 and 632 in FIG. 5) under the conversation history folders 1021 and 1022, and may directly store objects related to the group chat under the conversation history folders 1021 and 1022. In the example of FIG. 5, the objects generated in each session are stored under a session history folder corresponding to each session, but according to the example, the message store server may store all objects under a conversation history folder, without classifying them into separate session history folders when storing the objects.

Compared to the structure of FIG. 5, the message store server may not generate a group state object (e.g., group state object 675 of FIG. 5) and a session information object (e.g., session information object 670 of FIG. 5) when an event occurs in the group chat, and may store information corresponding to the event using the conference information object 1060. The conference information object 1060 may include information corresponding to attribute information included in the group state object and the session information object, and may store information on an event occurring in the group chat using attribute information defined in the conference information object 1060, without generating the group state object and the session information object.

The method of replacing attribute information of the group state object and the session information object using the conference information object 1060 has been described with reference to Tables 1 to 5 above.

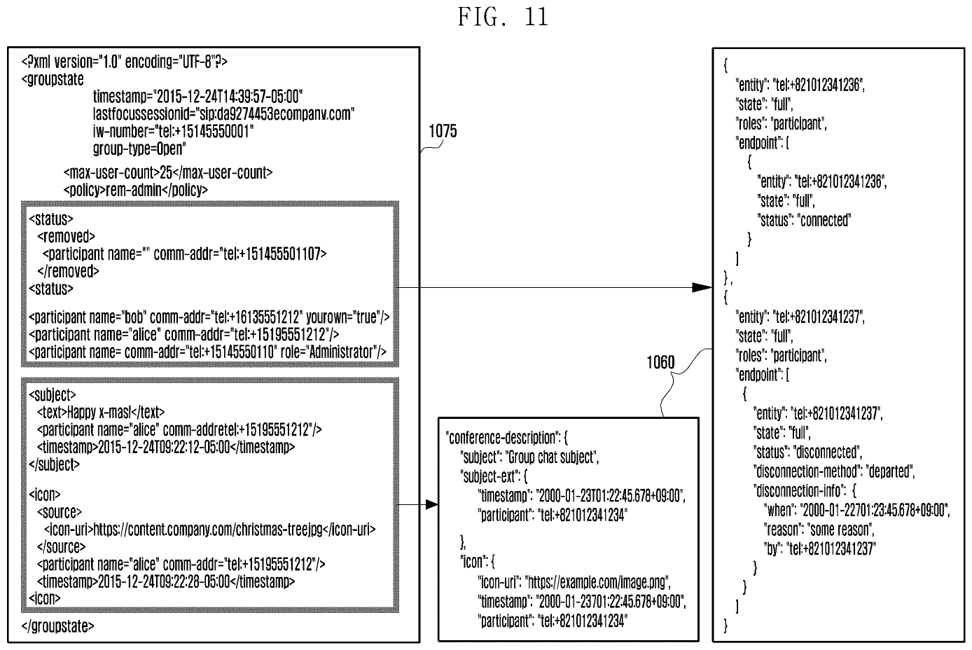

FIG. 11 is a diagram illustrating an example method of replacing information associated with a group state information object using information associated with a conference information object according to various embodiments.

According to an embodiment, in response to occurrence of an event related to a group chat, a message store server (e.g., message store server 200 in FIGS. 2 to 4, server device 200 in FIG. 8) may generate the conference information object 1060 including information associated with the event that occurs. The conference information object 1060 may be an object including information related to a change in the group chat. For example, the conference information object 1060 may include at least one of a session ID, a timestamp, a group type, participant information, a subject, an icon, the maximum number of users, and session information. The conference information object 1060 may include information corresponding to at least one attribute information included in a group state object 1075 and a session information object.

Referring to FIG. 11, the group state information object may include a participant status as attribute information. For example, when a predetermined participant leaves a chat room, the group state object 1075 may record the corresponding participant's status as removed. With regard to an event in which a participant leaves the chat room, the conference information object 1060 may record “disconnect” in user-endpoint-status.

In addition, the group state information object may include subject information of the chat room as attribute information. In the conference information object 1060, text in detailed information of the subject of the chat room may be recorded in conference description-subject, a participant may be recorded in conference description-subject text-participant, and a timestamp may be recorded in conference description-subject text-timestamp.

As described above, for information on the same event, the message store server may use information duplicated and recorded in the conference information object 1060, instead of using the group state object 1075.

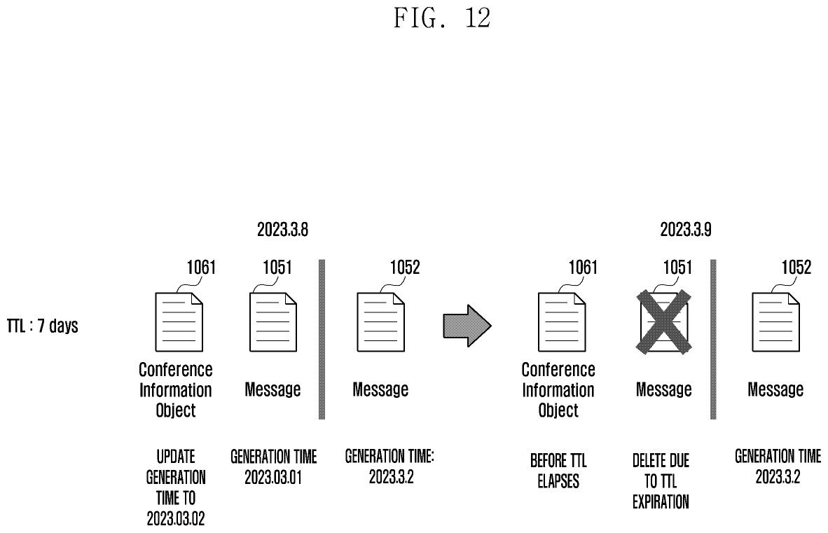

FIG. 12 is a diagram illustrating an example method of performing processing so that a conference information object is located at the top of a conversation history folder according to various embodiments.

According to an embodiment, a message store server (e.g., message store server 200 in FIGS. 2 to 4, and server device 200 in FIG. 8) may include a time to live (TTL) indicating a validity period of data in connection with storage of the data. The message store server may delete an object when a predetermined time elapses after the object is generated and stored. Accordingly, in the case of applying the TTL as it is, a synchronization operation may be unavailable with regard to a group chat after the TTL period elapses from the generation of the group chat.

According to an embodiment, the message store server may not delete a conference information object most recently generated in each group chat, although the TTL period elapses. The processor 210 may be configured to, when a new conference information object is generated as an event occurs in a group chat, store the generated conference information object at the top of a conversation history folder (or as the most recently generated one).

Referring to FIG. 12, a conference information object 1061 and a message object 1051 generated on March 1 may be recorded in a conversation history folder, and a message object 1052 generated on March 2 may be recorded in the conversation history folder. The TTL of each object in the message store server may be set to 7 days. In this case, when the TTL is applied as it is, the conference information object 1061 and the message object 1051 generated on March 1 may be deleted on March 9, when 7 days have passed.

According to an embodiment, since the message store server records the conference information object 1061 at the top of the conversation history folder, the generation time of the conference information object 1061 may also be updated to March 2 when the message object 1052 is recorded on March 2. Accordingly, although the message object 1051 generated on March 1 is deleted on March 9 when the TTL has expired, the conference information object 1061 may not be deleted.

According to an embodiment, a client (e.g., secondary device 400 of FIGS. 2 to 4, electronic device 400 of FIG. 9) may be configured to identify objects in the order of most recently generated objects when obtaining the information associated with the group chat for the first time, and may obtain the most recently generated conference information object 1061 stored at the top of the conversation history folder.

According to an embodiment, a new unique ID for processing a conference information object and SIP notify may be required. For example, a primary device may receive both a push message transmitted from a push server and an SIP message, and may need to identify whether the two messages are for the same object. In addition, since the push messages and SIP messages do not arrive in a predetermined order, the message store server may need to order the messages.

According to an embodiment, the message store server may add a timestamp usable for ordering and duplication processing of a message as a unique ID of the message. According to an embodiment, the message store server may generate a timestamp stored in the conference information object and SIP notify in a low unit (e.g., nano second) and may reduce the probability of duplication of a timestamp.

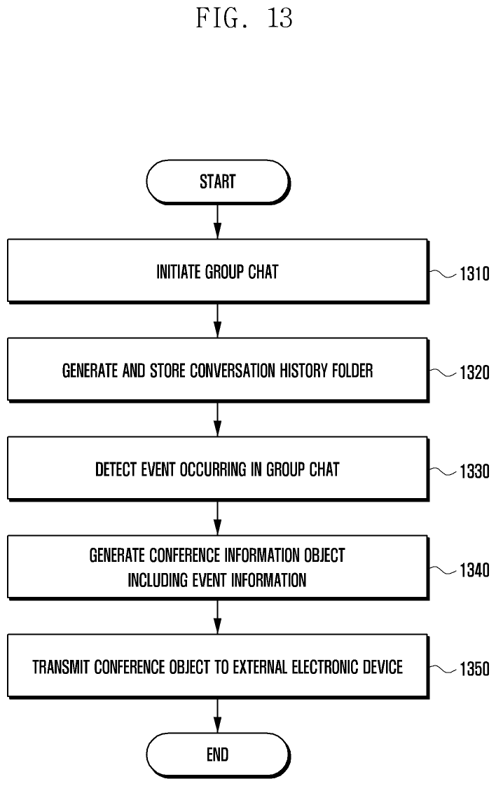

FIG. 13 is a flowchart illustrating an example method of processing a message by a server device according to various embodiments.

The method illustrated in FIG. 10 may be performed by a server device (e.g., message store server 200 of FIGS. 2 to 4, server device 200 of FIG. 8), and description of the technical features that have been described above may be omitted.

According to an embodiment, in operation 1310, the server device may identify that a group chat of a group including a first electronic device (or primary device) is initiated. The group chat may be a group chat in which messages are transmitted and received between multiple participants based on a rich communication service (RCS).

According to an embodiment, in operation 1320, when the group chat including the first electronic device is initiated, the server device may generate a conversation history folder (e.g., the conversation history folder 1022 of FIG. 10) including data related to the group chat and store the conversation history folder in a memory. The conversation history folder is stored under a user folder (e.g., user folder 1010 in FIG. 10), and may be a folder for storing information associated with each chat room to which a corresponding user belongs.

According to an embodiment, in operation 1330, the server device may identify (or detect) an event that occurs in the group chat. The group chat-related event may include various events occurring in the group chat, such as transmission of a message from a predetermined participant, a case in which a participant leaves the chat room, or a case in which a new participant joins the chat room.

According to an embodiment, in operation 1340, the server device may generate a conference information object (e.g., conference information object 1060 of FIG. 10) including event information. The conference information object 1060 may be an object including information related to a change in the group chat. For example, the conference information object may include at least one of a session ID, a timestamp, a group type, participant information, a subject, an icon, the maximum number of users, and session information. The conference information object 1060 may include information corresponding to at least one attribute information included in a group state object 1075 and a session information object. Since the conference information object includes the attribute information included in the group state object and the session information object, the server device may not generate the group state object and the session information object.

According to an embodiment, in operation 1350, the server device may transmit a conference object to a second electronic device (or secondary device). According to an embodiment, the second electronic device may acquire the conference information object from the server device, and update information associated with the group chat therefrom. The second electronic device may apply the event-related content to a group chat-related UI.

According to an embodiment, the order of the operations illustrated in FIG. 13 may be changed, and/or at least some of the operations may be performed in parallel.

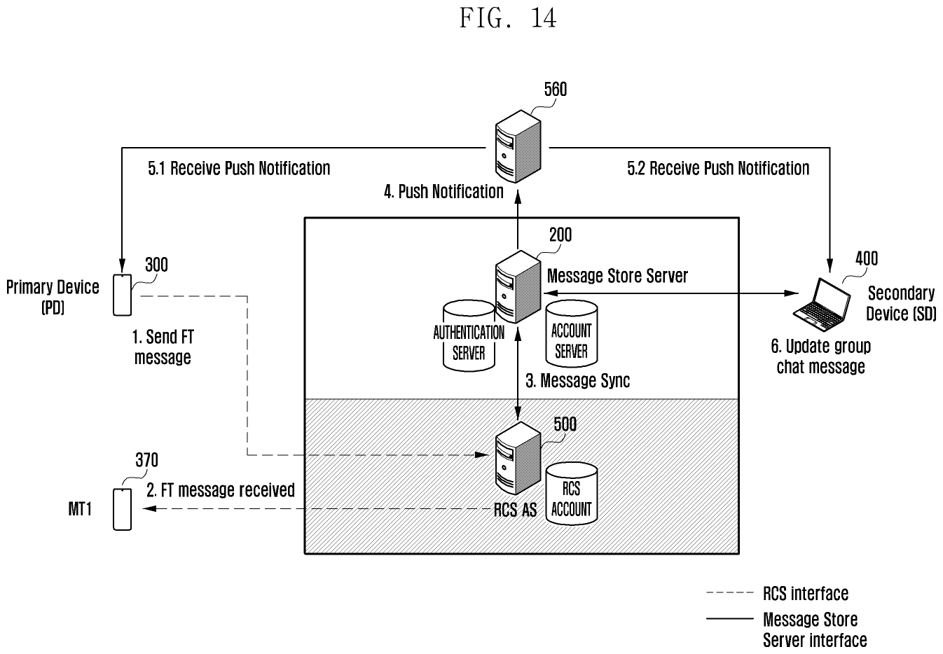

FIG. 14 is a diagram illustrating example operation of each entity when file transfer is performed by a primary device in a message transmission and reception system according to various embodiments.

The entities illustrated in FIG. 14 may have the same components and/or functions as the entities described in FIG. 3 and FIG. 4.

According to an embodiment, a primary device 300 may transmit a message including a file. A native client of the primary device 300 may transmit a file message to the rich communication service application server (RCS AS) 500 using an RCS scheme.

According to an embodiment, the RCS AS 500 may transmit the file message transmitted from the primary device 300 to another mobile terminal (e.g., MT1 370). An interface between the RCS AS 500 and the primary device 300 or other mobile terminal may be configured as an RCS interface, and the primary device 300 and the other mobile terminal may access the RCS AS 500 using respective RCS accounts.

According to an embodiment, the RCS AS 500 may transfer the file message transmitted from the primary device 300 to the message store server 200. According to an embodiment, the RCS AS 500 may copy the file to the message store server 200, or transfer a link of the RCS AS 500 that proxies a URL of the file.

According to an embodiment, the message store server 200 may identify a connected client from the received group chat message. The message store server 200 may transmit a push message (or push notification) to the push server 560 so as to transmit the push message to a device of the identified client. In this case, the message store server 200 may provide information (e.g., account, IMEI, IP address, etc.) of a recipient of the push message to the push server 560, and the push server 560 may transmit the push message to the recipient's client (e.g., native client and/or downloadable client).

According to an embodiment, when the push message is received, the primary device 300 may identify that the push message is related to the file message transmitted by itself. The primary device 300 may not perform a separate operation in response to reception of the push message, since an update is caused due to the file message transmitted by itself.

According to an embodiment, when the push message is received, the secondary device 400 may identify the file message from the message store server 200 using information included in the push message. For example, the push message may include URL information from which the file message may be acquirable, and the secondary device 400 may access the message store server 200 using the corresponding URL information and acquire the file message.

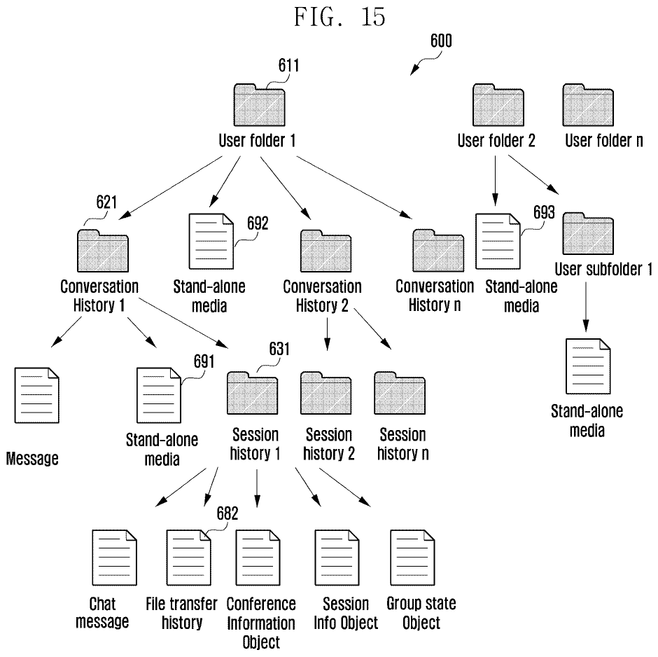

FIG. 15 is a diagram 600 illustrating an example structure of folders and objects stored in a message store server according to various embodiments.

The structure illustrated in FIG. 15 may be substantially the same as the structure of FIG. 5, and an object related to file transfer will be described in the following description.

According to an embodiment, the file transfer history object 682 may be an object including information related to a file transmitted and received between clients.

Table 6 illustrates an example of attribute information included in the file transfer history object 682.

TABLE 6

| Attribute | Description |
|---|---|
| From | Set to the address of the initiator of the CPM |
| | request or response, or legacy message. |
| Message-Context | Information about the way the user expects to |
| | interact with the message |
| Date | The date and time when the recording of the |
| | CPMrequest was started. |
| To | Set to the address of the recipient of the CPM |
| | request or response, or of the legacy message. |
| Direction | ”In” is set for incoming traffic; |
| | ”Out” is set for traffic outgoing from |
| | the CPM User. |
| Conversation-ID | The ID that identifies the CPM Conversation |
| | Identity that is associated with CPM Messages. |
| Contribution-ID | The ID that identifies the CPM Contribution |
| | Identity of an CPM Messages. |
| InReplyTo- | The ID that, in case of a reply to an earlier |
| Contribution-ID | received CPMMessages, identifies the Contribution- |
| | ID of the CPM Messages. |
| correlationId | Key ID for message duplication check |
| | RCS: IMDN ID, MMS: MMS ID. |

According to an embodiment, the file transfer history object 682 may include information related to an actual thumbnail file, and the thumbnail file may be included in a raw data form. In addition, the file transfer history object 682 may include information related to an actual original file, and the original file may be included in a raw data form.

According to an embodiment, the stand-alone media object 691, 692, or 693 may be an object including an actual file. For example, the stand-alone media objects 691, 692, or 693 may be implemented based on a message concept of IMAP4 and may be generated as an MIME format object in order to conform to an IMAP4 message (e.g., voice mail messages).

According to an embodiment, the conversation history folder 621 corresponding to a predetermined chat room may be generated under the user folder 611. Under the conversation history folder 621, a message object and the stand-alone media object 691 may be stored. The objects that are not stored under the session history folder 631 but are directly stored under the conversation history folder 621 may be objects related to a legacy message service (or xMS).

According to an embodiment, the session history folder 631 may be generated under the conversation history folder 621. Under the session history folder 631, the file transfer history object 682 may be generated. The objects stored under the session history folder 631 may include information associated with events occurring during a session period generated in the corresponding chat room, and an object may be generated under the session history folder 631 when a message is transmitted or received in an RCS scheme.

A file processing method of the message store server disclosed in FIGS. 14 and 15 may be described as follows.

According to an embodiment, when a CPIM file message that is exchanged between a client (e.g., native client of primary device) or an RCS AS exists, the client and/or the RCS AS may attempt a post so as to store the corresponding message in the message store server. A file to be transmitted may be stored in a binary form inside a post syntax transmitted to the message store server.

According to an embodiment, the message store server may generate information associated with the post as an object and store the object. Subsequently, the client (e.g., downloadable client of secondary device) may attempt to perform an object get with respect to the message store server for message synchronization. In response to this, the message store server may transfer the stored object information to the client.

According to an embodiment, the client may update message information using the acquired message object information. In this case, as the information on the file, information on a file transfer tag may be used. In addition, the client may download, as the actual file, each binary file separated by a boundary using a content ID

In this manner, when a file is transferred in the form of a binary within a post syntax, the following problems may occur.

Since the file is transmitted in the form of a binary inside the POST syntax, the size of the transferrable file may be limited. For example, a limit on a file size, such as 100 MB to 300 MB, may be required. For a large file exceeding this, it may be difficult to attach a binary file in a post body because the object size may become too large. In addition, when the size of the body of the posted object is too large, there may be a problem in processing a request in the HTTP protocol, and when an error occurs in the process of requesting a post, there may be a problem in that the post request needs be uploaded from the beginning.

In addition, a file message and a chat message may have a difference in a storage period (or TTL) from the viewpoint of server capacity management. For example, a chat message with a small size may be set to 7 days, and a file message may be set to 3 days, so that the file message has a shorter storage period. According to the above-described scheme, since the message object includes information associated with the actual file, when the file is deleted due to the expiration of the storage period, the message is also deleted, and thus a subsequent synchronization operation may not be performed.

In addition, since all requests related to file transfer are made through the message store server, the load of the message store server may increase. It may be difficult to apply a flexible server policy to the message store server because it is difficult to apply an individual policy for file transfer.

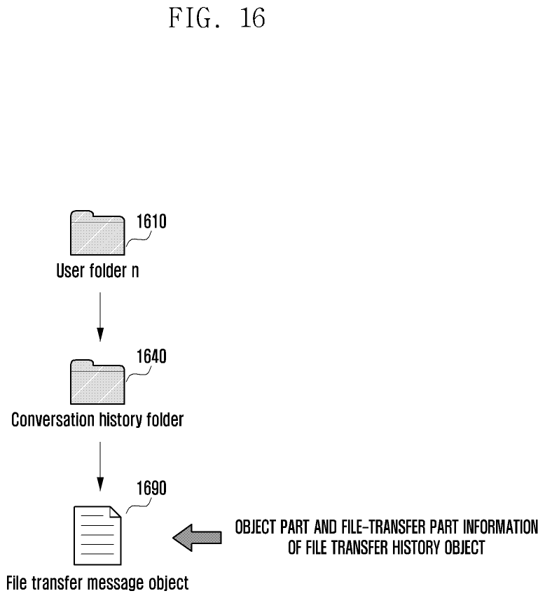

Embodiments for addressing the above-described problems will be described in greater detail below with reference to FIGS. 16 to 19.

FIG. 16 is a diagram illustrating an example structure of folders and objects stored in a message store server according to various embodiments.

According to an embodiment, a conversation history folder 1640 for storing information associated with a predetermined chat room may be generated under a user folder 1610. The conversation history folder 1640 may store various objects related to messages transmitted and received, for example, a file transfer message object 1690 including information related to file transfer.

According to an embodiment, the message store server may modify an object part and a file transfer part existing in an existing file transfer history object (e.g., file transfer history object 682 in FIG. 15) and store the result as the file transfer message object 1690.

Table 7 shows an example of an object part of a file transfer history object.

```
TABLE 7
  POST /nms/v1/base/tel:+12021308085/objects HTTP/1.1
  ...
  --LH6uxl4xe5sJ93157iJLOyNl
  Content-Disposition: form-data; name=root-fields
  Content-Type: application/json; charset=UTF-8
  {
    “object”: {
      “parentFolder”:
“http://server/nms/v1/base/tel:+12021308085/folders/UGZa5FY4o1S1oTSQSQC”,
      “attributes”: {
        “attribute”: [{
          “name”: “From”,
          “value”: [“+1818118181”]
        }, {
          “name”: “Message-Context”,
          “value”: [“file-message”]
        }, {
          “name”: “Date”,
          “value”: [“1997-11-21T15:55:06Z”]
        }, {
          “name”: “To”,
          “value”: [“+1818118181”]
        }, {
          “name”: “Direction”,
          “value”: [“IN”]
        }, {
          “name”: “Conversation-Id”,
          “value”: [“f81d4fae-7dec-11d0-a765-00a0c91e6bf6”]
        }, {
          “name”: “Contribution-Id”,
          “value”: [“abcdef-1234-5678-90ab-cdef01234567”]
        }, {
          “name”: “InReplyTo-Contribution-Id”,
          “value”: [“01234567-89ab-cdef-0123-456789abcdef”]
        }]
      },
      “correlationId”: “654131a654131a131bfrufh37846r44tcbrfb94656”
    }
  }
```

Table 8 shows an example of a file transfer part of a file transfer history object.

```
TABLE 8
--LH6uxl4xe5sJ93i57iJLOyNl
Content-Disposition: form-data; name=message
Content-Type: multipart/related; boundary=4vImznJai6jqZFelH2zuHe+P;
type=“Application/X-CPM-File-Transfer”
--4vImznJai6jqZFelH2zuHe+P
Content-Disposition: attachment; filename=sms; name=sms
Content-Type: Application/X-CPM-File-Transfer; charset=utf-8
<?xml version=“1.0” encoding=“UTF-8”?>
<file-transfer>
  <file-transfer-type>1-1</file-transfer-type>
  <sdp>
    i=This is my latest picture
    a=sendonly
    a=file-selector:name:“My picture.jpg” type:image/jpeg size:4092
    a=file-disposition:render
    a=file-date:creation: “Mon, 15 May 2006 15:01:31 +0300”
    a=file-icon:cid:mythumbnail@example.com
  </sdp>
  <file-object>
    <cid>cid:1234@example.com</cid>
  </file-object>
</file-transfer>
```

According to an embodiment, the file transfer message object 1690 may include the object part of the file transfer history object in Table 7 and the file transfer part of the file transfer history object in Table 8. Table 9 shows an example of attribute information included in the file transfer history object 1690.

TABLE 9

| Attribute | Description |
|---|---|
| From | Set to the address of the initiator of the CPM |
| | request or response, or legacy message. |
| Message-Context | Information about the way the user expects to |
| | interact with the message |
| Date | The date and time when the recording of the |
| | CPMrequest was started. |
| To | Set to the address of the recipient of the CPM |
| | request or response, or of the legacy message. |
| Direction | ”In” is set for incoming traffic; |
| | ”Out” is set for traffic outgoing from |
| | the CPM User. |
| P-Asserted-Service | The information that is derived service |
| | identification |
| | urn:urn-7:3gpp-service.ims.icsi.oma.cpm.session |
| | (Identifies in SIP INVITE a request for CPM chat) |
| | urn:urn-7:3gpp-service.ims.icsi.oma.cpm.filetransfer |
| | (Identifies in SIP INVITE a request for CPM File |
| | Transfer) |
| | urn:urn-7:3gpp-service.ims.icsi.oma.cpm.msg |
| | (Identifies in a SIP MESSAGE a CPM Standalone |
| | Message) |
| Content-Type | MIME-type for file(e.g. image/png) |

Table 10 and Table 11 are examples of a file transfer message object and a description thereof.

```
TABLE 10
“resourceURL”:“https://oasis-
endpoint/nms/v1/os/tel%3A%2B821022223333/objects/1124b7c8- 1929-11ed-861d-
0242ac120002”,
    “path”: “/main/tel:+821022224444/1124b7c8-1929-11ed-861d-0242ac120002”,
    “payloadPart”: [
    {
      “contentType”: “image/png”,
      “contentDisposition”: “attachment; filename=some_photo.png”,
      “disposition”: “attachment”,
      “size”: “1234”,
      “href”: “https://oasis-endpoint/file-store/40RGMWzwve6m”,
      “fileIcon”: “cid:thumbnail_1”
    },
    {
      “contentType”: “image/png”,
      “contentDisposition”: “icon”,
      “disposition”: “attachment”,
      “contentId”: “thumbnail_1”,
      “size”: “123”,
      “href”: “https://oasis-endpoint/file-store/qVzLGkbertL5”
    }
    ],
    “correlationId”: “1124b7c8-1929-11ed-861d-0242ac120002”,
    “lastModSeq”: 48
  }
```

TABLE 11

| Name | Description |
|---|---|
| payloadPart | Information about individual payload parts. |
| contentType | MIME-type for file(e.g. image/png) |
| contentDisposition | The Content-Disposition of this part. For |
| | example: “attachment”, “icon”. |
| size | Indicates the size of the stored content in bytes. |
| href | Link to the stored content. |
| fileIcon | The File-Icon of this payload part, e.g., its |
| | thumbnail or icon |
| disposition | One of “attachment”, “render”. |
| playingLength | The length of audio file. |
| correlationId | Unique correlation ID associated with the object, |
| | if any. |
| lastModSeq | Last mod-sequence value associated with the object |

According to an embodiment, the message store server may manage stored each individual data using various configuration information. For example, the message store server may add a configuration so that a client may perform processing based on a file size. In addition, a configuration related to various server roots may be added so that the client may perform processing.

According to an embodiment, the message store server may store an actual file and an object separately. For example, the message store server may not include a message and a file in one object, but may store the related information separately from each other. In this case, the file may be stored at a predetermined location of the server, and an object including the location of the stored file and a message content may be separately generated and stored. Through this, the file and the message may be processed individually.

According to an embodiment, the message store server and the client may apply a different file upload method to a large file than to a small file. For example, the client may not transmit a file in the form of a binary inside a post syntax, but may directly upload the file to a designated server path. In this case, the message store server may support retransmission and suspension functions during file upload and download.

According to an embodiment, server management may be performed by applying various configurations according to a server policy. For example, a file size based configuration may be added so that the client may perform processing based on a file size. max_small_file_size, which is an example of a file size-based configuration, may indicate the maximum size capable of being processed as a small file.

According to an embodiment, the message store server may add a file server based configuration, which is a configuration related to various server roots, to allow the client to perform processing. For example, small_file_server_root may be defined as a server root storing a small file, large_file_server_root may be defined as a server root storing a large file, and free_file_server_root may be defined as a server root storing a free file.

According to an embodiment, the client may compare the size of a file to be uploaded with a defined configuration when uploading the file, and may determine a root for storing the file. For example, in the case of a file having a file size smaller than max_small_file_size, the file may be stored through small_file_server_root, in the case of a file having a file size larger than max_small_file_size, the file may be stored through large_file_server_root, and in the case of a file to which a free of charge policy is applied, the file may be stored through free_file_server_root. Accordingly, server load distribution, traffic control, and charging policy may be more easily implemented.

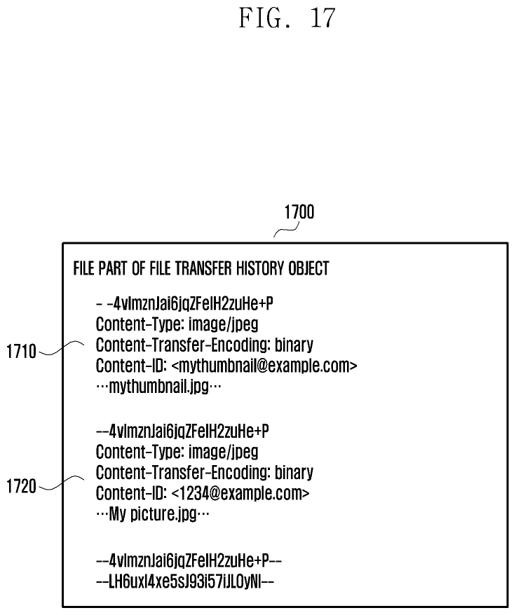

FIG. 17 is a diagram illustrating an example method of separating a file part from a file transfer object according to various embodiments.

According to an embodiment, a message store server may separate a message part and the file part of the file transfer history object and store them in separate file folders.

Referring to FIG. 17, a file transfer history object 1700 may include thumbnail file data 1710 and original file data 1720. According to an embodiment, the message store server may store the thumbnail file data 1710, which is small, under a small file folder, and may store the original file data 1720, which is large, under a large file folder.

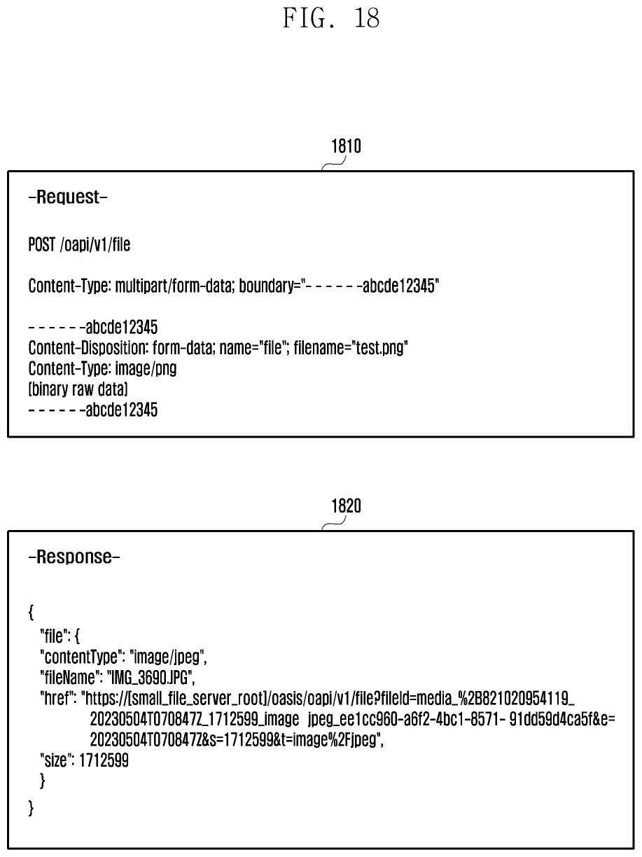

FIG. 18 is a diagram illustrating an example message transmitted and received when a small file is uploaded by a client according to various embodiments.

According to an embodiment, when a file is smaller than max_small_file_size, the client may store the corresponding file through small_file_server_root. The client may include a small file in a post request 1810 and transmit the same.

FIG. 18 illustrates an example of a post request that the client transmits in the case of uploading of a small file and a response transmitted by a message store server.

According to an embodiment, when the client determines that the file is a small file, the client may upload the file through the post request 1810. In this case, when multiple files are uploaded together, each file may be distinguished by the boundary. The client may include binary raw data of the actual file in the post request 1810 and may perform transmission to the message store server.

According to an embodiment, the message store server may store the received file in a small file server. After storing the file, the message store server may transmit, to the client, a response 1820 including the location and information associated with the stored file. The client may use content of the received response 1810 for object generation in the future.

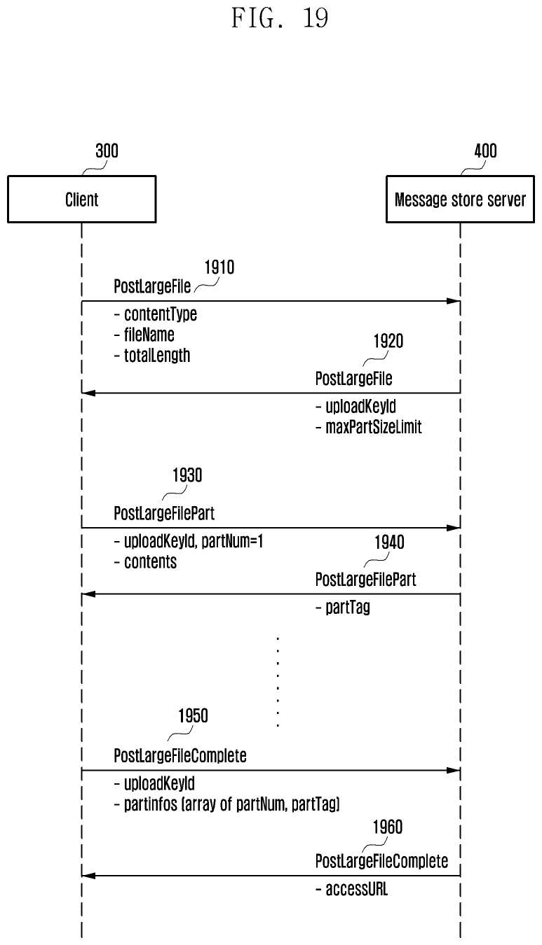

FIG. 19 is a signal flow diagram illustrating an example operation of a client and a message store server when a large file is uploaded according to various embodiments.

According to an embodiment, in operation 1910, the client (300) may transmit a request to register a large file to the message store server. When a file is larger than max_small_file_size, the client may determine that the file to be transmitted is a large file. The client may transmit a post request (PostLargeFile) including file-related information to the message store server. The post request may include a content type, a file name, and a length of a message.

According to an embodiment, in operation 1920, the message store server (400) may transmit a post response (PostLargeFile) in response to the post request of client. The post response may include a key (e.g., uploadkeyID) to be used for file uploading and a minimum and maximum capacity for dividing and transmitting the file.

According to an embodiment, the client may divide the file using the information associated with the received post response. In this case, the client may divide the large file based on a size in the range between the minimum and maximum capacities included in the post response. The client may assign a part number for each divided part.

According to an embodiment, in operation 1930, the client may transmit a post request (PostLargeFilePart) including part 1 among the divided parts of the file to the message store server. The post request may include the received upload key, a number of the file part being transmitted, and content of the corresponding part. The client may call an API for each of the divided parts and upload the same to the message store server.

According to an embodiment, in operation 1940, when the upload of part 1 is completed, the message store server may transmit a post response (PostLargeFilePart) including a completed tag value to the client.

According to an embodiment, the client may perform operation 1930 for each of the n divided parts, and the message store server may perform operation 1940 in response to reception of each of the n parts.

According to an embodiment, when all parts are uploaded completely, the client may transmit information including an upload key (uploadjeyID), a part number, and a part tag to the message store server via a post request (PostLargeFileComplete) in operation 1950.

According to an embodiment, the message store server may combine the divided parts, obtained via transmission, so as to restore one large file, and then store the same. In operation 1960, the message store server may transfer information including an access URL of the stored large file to the client via a post response (PostLargeFileComplete). The client may use the received access URL for object generation at a later time.

Table 12 shows an example of the post request that the client transmits after uploading all parts of the large file in operation 1950 and the post response transmitted by the message store server in operation 1960.

```
TABLE 12
-Request-
“uploadedPartInfos”: [
  {
    “partNum”: 1,
    “partTag”: “9d70af76bb64738c2e962bb75be76df4”
  },
  {
    “partNum”: 2,
    “partTag”: “d80a1e1d67ae73c0cbc0b66c145022c6”
  }
]
-Response-
{“accessURL”:“https://[large_file_server_root]/oapi/v1/large-
file?fileId=media_%2B821015003144_a33bf92b-5f15-4fe1-929d-bcc5ab23238b”}
```

The server device 200 according to various example embodiments of the disclosure may include the communication interface 230, the memory 220, and the processor 210 operatively connected to the communication interface 230 and the memory 220.

According to an example embodiment, when a group chat of a group including the first electronic device 300 is initiated, the processor 210 may be configured to generate the conversation history folder 1022 including data related to the group chat and store the generated folder in the memory 220, to generate, in response to occurrence of an event related to the group chat, the conference information object 1060 including information associated with the event and store the generated object in the conversation history folder 1022, and to transmit the generated conference information object 1060 to the first electronic device 300 and the second electronic device 400 corresponding to the first electronic device 300 via the communication interface 230.

According to an example embodiment, the conference information object 1060 may include at least one of a session ID, a timestamp, a group type, participant information, a subject, an icon, the maximum number of users, and session information.

According to an example embodiment, the conference information object 1060 may include information corresponding to at least one attribute information included in a group state object and a session information object, and the processor 210 may be configured not to generate the group state object and the session information object in response to the event.

According to an example embodiment, the conversation history folder 1022 may be generated under the user folder 1010 that stores message information transmitted and received by the first electronic device 300.

According to an example embodiment, the processor 210 may be configured to store, in the conversation history folder 1022, a plurality of conference information objects respectively including information associated with events that occur during a plurality of session periods generated in the group chat.

According to an example embodiment, the processor 210 may be configured to generate the conference information object 1060 including all predefined attribute information when the event occurs.

According to an example embodiment, the group chat is based on rich communication services (RCS), and the processor 210 may be configured to receive event information from the external RCS server 500 via the communication interface 230 when the event occurs.

According to an example embodiment, the event may include transmission of a message in the group chat and a change of a participant in the group chat.

According to an example embodiment, the first electronic device 300 may include the native client 360 supporting the RCS, and the second electronic device 400 may exclude the native client.

According to an example embodiment, the processor 210 may be configured to transmit the generated conference information object 1022 to the external push server 560 via the communication interface 230, and the second electronic device 400 may obtain the conference information object 1022 using information included in a push message transmitted from the push server 560.

A message processing method by the server device 200 according to various example embodiments may include operation 1320 of generating and storing a conversation history folder including data related to a group chat when a group chat of a group including the first electronic device 300 is initiated, operation 1340 of generating a conference information object including information associated with an event related to the group chat and storing the generated object in the conversation history folder in response to occurrence of the event, and operation 1360 of transmitting the generated conference information object to the first electronic device 300 and the second electronic device 400 corresponding to the first electronic device 300.

According to an example embodiment, the conference information object may include at least one of a session ID, a timestamp, a group type, participant information, a subject, an icon, the maximum number of users, and session information.

According to an example embodiment, the conference information object may include information corresponding to at least one attribute information included in a group state object and a session information object, and the operation of generating the conference information object including the information associated with the event may include an operation of not generating the group state object and the session information object in response to the event.

According to an example embodiment, the conversation history folder may be generated under a user folder that stores message information transmitted and received by the first electronic device.

According to an example embodiment, the operation of generating and storing the conference information object in the conversation history folder may include an operation of storing a plurality of conference information objects respectively including information associated with events that occur during a plurality of session periods generated in the group chat.

According to an example embodiment, the operation of generating the conference information object may include an operation of generate the conference information object including all predefined attribute information when the event occurs.

According to an example embodiment, the group chat is based on rich communication services (RCS), and the method may further include an operation of receiving event information from an external RCS server via the communication interface when the event occurs.

The electronic device 400 according to various example embodiments of the disclosure may include the display 440, the communication module 430, the memory 420, and the processor 410 operatively connected to the communication module 430 and the memory 420.

According to an example embodiment, the processor 410 may be configured to perform a group chat function using a client stored in the memory 420, to obtain, from an external message server via the communication module 430, a conference information object generated as an event related to the group chat occurs, to update information associated with the group chat in response to the conference information object, and to display the updated group chat information on the display 440.

According to an example embodiment, the processor 410 may be configured to receive a push message corresponding to the event from an external push server via the communication module 430, and to obtain the conference information object from the message server using information included in the push message.

According to an example embodiment, the conference information object may include at least one of a session ID, a timestamp, a group type, participant information, a subject, an icon, the maximum number of users, and session information.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that the various embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in various embodiments of the disclosure, the term “module” may include a unit implemented in hardware, software, or firmware, or any combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include codes generated by a compiler or code executable by an interpreter. The machine-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a purchaser. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A server device comprising:
a communication interface comprising communication circuitry;
a memory; and
at least one processor, comprising processing circuitry, operatively connected to the communication interface and the memory,
wherein the memory stores instructions that are executable by the at least one processor and, at least one processor, individually and/or collectively, is configured to execute the instructions and to cause the server device to:
based on a group chat of a group including a first electronic device being initiated, generate a conversation history folder including data related to the group chat and store the generated folder in the memory;
in response to occurrence of an event related to the group chat, generate a conference information object including information on the event and store the generated object in the conversation history folder; and
transmit the generated conference information object to the first electronic device and a second electronic device corresponding to the first electronic device via the communication interface.

2. The server device of claim 1, wherein the conference information object comprises at least one of a session ID, a timestamp, a group type, participant information, a subject, an icon, a maximum number of users, and session information.

3. The server device of claim 1, wherein the conference information object comprises information corresponding to at least one attribute information included in a group state object and a session information object, and
wherein at least one processor, individually and/or collectively, is configured to cause the server device to not generate the group state object and the session information object, in response to the event.

4. The server device of claim 1, wherein the conversation history folder is generated under a user folder that stores message information transmitted and received by the first electronic device.

5. The server device of claim 1, wherein the at least one processor, individually and/or collectively, is configured to cause the server device to store, in the conversation history folder, a plurality of conference information objects including information on respective events occurring during a plurality of session periods generated in the group chat.

6. The server device of claim 1, wherein at least one processor, individually and/or collectively, is configured to cause the server device to, based on the event occurring, generate the conference information object including specified attribute information.

7. The server device of claim 1, wherein the group chat includes a group chat based on rich communication services (RCS), and
wherein at least one processor, individually and/or collectively, is configured to cause the server device to, based on the event occurring, receive event information from an external RCS server via the communication interface.

8. The server device of claim 1, wherein the event may include transmission of a message in the group chat and a change of a participant in the group chat.

9. The server device of claim 7, wherein the first electronic device comprises a native client configured to support the RCS, and
wherein the second electronic device does not include a native client.

10. The server device of claim 1, wherein at least one processor, individually and/or collectively, is configured to cause the server device to transmit the generated conference information object to an external push server via the communication interface, and
wherein the second electronic device is configured to obtain the conference information object using information included in a push message transmitted from the push server.

11. A method of processing a message by a server device, the method comprising:
based on a group chat of a group including a first electronic device being initiated, generating and storing a conversation history folder including data related to the group chat;
in response to occurrence of an event related to the group chat, generating a conference information object including information on the event and storing the generated object in the conversation history folder; and
transmitting the generated conference information object to the first electronic device and a second electronic device corresponding to the first electronic device.

12. The method of claim 11, wherein the conference information object comprises at least one of a session ID, a timestamp, a group type, participant information, a subject, an icon, a maximum number of users, and session information.

13. The method of claim 11, wherein the conference information object comprises information corresponding to at least one attribute information included in a group state object and a session information object, and
wherein the generating of the conference information object including the information on the event comprises not generating the group state object and the session information object, in response to the event.

14. The method of claim 11, the conversation history folder may be generated under a user folder that stores message information transmitted and received by the first electronic device.

15. The method of claim 11, wherein the generating of the conference information object and storing of the generated conference information object in the conversation history folder comprises:
storing a plurality of conference information objects including information on respective events occurring during a plurality of session periods generated in the group chat.

16. The method of claim 11, wherein the generating of conference information object comprises:
generating conference information object including all predefined attribute information when the event occurs.

17. The method of claim 11, wherein the group chat includes a group chat based on rich communication services (RCS), and
wherein the method further comprises, based on the event occurring, receiving event information from an external RCS server.

18. An electronic device comprising:
a display;
a communication module comprising communication circuitry;
a memory; and
at least one processor, comprising processing circuitry, operatively connected to the display, the communication module, and the memory,
wherein the memory stores instructions that are executable by at least one processor and, at least one processor, individually and/or collectively, is configured to execute the instructions and to cause the electronic device to:
perform a group chat function using a client stored in the memory;
obtain, from an external message server via the communication module, a conference information object generated based on occurrence of an event related to the group chat;
update information on the group chat, in response to the conference information object; and
display the updated information on the group chat on the display.

19. The electronic device of claim 18, wherein the at least one processor, individually and/or collectively, is configured to:
receive a push message corresponding to the event from an external push server via the communication module, and
obtain the conference information object from the message server by using information included in the push message.

20. The electronic device of claim 18, wherein the conference information object comprises at least one of a session ID, a timestamp, a group type, participant information, a subject, an icon, a maximum number of users, and session information.
